(19) United States
(12) Patent Application Publication
(10) Pub. No.: US 2024/0333056 A1
(43) Pub. Date: Oct. 3, 2024

(54) ROTATING ELECTRIC MACHINE AND METHOD OF MANUFACTURING ROTATING ELECTRIC MACHINE

(71) Applicant: HONDA MOTOR CO., LTD., Tokyo (JP)

(72) Inventor: Eiji Shirado, Wako-shi (JP)

(21) Appl. No.: 18/616,259

(22) Filed: Mar. 26, 2024

(30) Foreign Application Priority Data
Mar. 29, 2023 (JP) 2023-053651

(51) Int. Cl. H02K 3/14; H02K 1/16; H02K 15/04

(52) U.S. Cl. CPC H02K 3/14; H02K 1/16; H02K 15/0414

(57) ABSTRACT

A rotating electric machine includes a stator, and a rotor. The stator has a rod-shaped coil which is disposed in a slot of a stator core and the rod-shaped coil includes plate conductors having slits formed in a twisted state. The rotor is disposed adjacent to a stator core and rotates. The rod-shaped coil is continuously wound on the stator core. In the rod-shaped coil, the number of slits of the plate conductor disposed on a side close to the rotor is greater than the number of slits of the plate conductor disposed on a side separated from the rotor.

### CROSS-REFERENCE TO RELATED APPLICATION

Priority is claimed on Japanese Patent Application No. 2023-053651, filed Mar. 29, 2023, the content of which is incorporated herein by reference.

### BACKGROUND OF THE INVENTION

### Field of the Invention

The present invention relates to a rotating electric machine and a method of manufacturing the rotating electric machine.

### Description of Related Art

In a rotating electric machine, for example, a configuration provided with a rod-shaped coil including a plate conductor in a slot of a stator core and a slit formed in an axial direction of the stator core in a twisted state is known (for example, see Japanese Patent No. 6366198). By forming the slit in the plate conductor in the twisted state, loss due to eddy current generated in the plate conductor (i.e., coil eddy current loss) can be minimized.

### SUMMARY OF THE INVENTION

Incidentally, the plate conductor of the rod-shaped coil is, for example, disposed (arranged) to be stacked from an outer circumferential side of a stator core to a rotor side by being continuously wound spirally around the stator core. In the plate conductor disposed in this way, it is known that an inter-linkage magnetic flux amount generated in the plate conductor near the rotor gets large, and coil eddy current loss of the plate conductor near the rotor is increased. Here, by further suppressing the coil eddy current loss generated in the plate conductor arranged on the rotor side, it is possible to effectively suppress the coil eddy current loss of the rod-shaped coil, and it is desired to put a technology that can contribute to energy efficiency into practical use.

An aspect of the present invention is directed to providing a rotating electric machine and a method of manufacturing the rotating electric machine capable of effectively suppressing coil eddy current loss of a rod-shaped coil and contributing to energy efficiency.

An aspect of the present invention proposes the following configurations.

(1) A rotating electric machine (for example, a rotating electric machine 10 of an embodiment) according to the present invention includes a stator (for example, a stator 11, 201 in the embodiment) having a rod-shaped coil (for example, a rod-shaped coil 25, 120 in the embodiment) which is disposed in a slot (for example, a slot 23 in the embodiment) of a stator core (for example, a stator core 21 of the embodiment), the rod-shaped coil including plate conductors (for example, plate conductors 31, 31A, 31B, 100, 124, 205 of the embodiment) in which slits (for example, slits 42, 56, 140 of the embodiment) are formed at least partially in a twisted state from one end (for example, one end 31Aa, 31Ba, 100a, 124a of the embodiment) toward the other end (for example, the other end 31Ab, 31Bb, 100b, 124b of the embodiment) in an axial direction, and
a rotor (for example, a rotor 12 in the embodiment) that is disposed adjacent to the stator and that rotates,
the rod-shaped coil being continuously wound on the stator core, and
a number of slits of the plate conductor (for example, the plate conductor 31A, 100, 124 of the embodiment) disposed on a side close to the rotor is greater than a number of slits of the plate conductor (for example, the plate conductor 31B of the embodiment) disposed on a side separated from the rotor.

Here, the plate conductor disposed on the side close to the rotor is largely affected by coil eddy current loss. Here, in this configuration, the number of slits of the plate conductor disposed on the side close to the rotor is greater than the number of slits of the plate conductor disposed on the side separated from the rotor. Accordingly, in the plate conductor disposed on the rotor side, large eddy current can be divided into small eddy currents by the slit. Accordingly, occurrence of the coil eddy current loss in the plate conductor disposed on the rotor side can be appropriately minimized. Accordingly, the coil eddy current loss of the rod-shaped coil spirally wound on the stator core can be appropriately minimized to contribute to energy efficiency.

In addition, by forming the slit in the twisted state from one end to the other end of the plate conductor in the axial direction of the stator, an induction voltage difference between the plate conductors can be reduced. Accordingly, loss due to circulating current flowing through the plate conductor (i.e., circulation loss) can be divided and reduced by the slit in the twisted state.

(2) In the above-mentioned aspect, in the plate conductor disposed on the side close to the rotor, a thickness (for example, a thickness T1 in the embodiment) of the stator core in a radial direction may be greater than a thickness (for example, a thickness T2 in the embodiment) of the plate conductor disposed on the side separated from the rotor.

According to this configuration, the thickness of the plate conductor disposed on the side close to the rotor is greater than the thickness of the plate conductor on the side separated from the rotor. Accordingly, a cross-sectional area of the plate conductor disposed on the rotor side can be increased. Accordingly, a range in which the slit is formed in the twisted state in the plate conductor disposed on the side close to the rotor can be secured.

(3) In the above-mentioned aspect, in the plate conductor disposed on the side close to the rotor, a dividing slit (for example, a dividing slit 62, 66, 105, 145, 146 of the embodiment) may be formed such that the dividing slit extends in a circumferential direction of the stator core, the dividing slit being configured to divide the plate conductor disposed on the side close to the rotor into a plurality of layers in the radial direction, and the slit may be formed in a twisted state in each of the plurality of divided layers.

According to this configuration, by dividing the plate conductor disposed on the side close to the rotor into the plurality of layers using the dividing slit, the slit independent from each layer can be formed in the twisted state. Accordingly, a range in which a large number of slits are formed in the twisted state in the plate conductor disposed on the side close to the rotor can be secured.

(4) In the above-mentioned aspect, all of the plate conductors that are disposed between the side close to the rotor and the side separated from the rotor and that forms the rod-shaped coil may be formed to have same cross-sectional areas with each other.

According to this configuration, as the cross-sectional area of all the plate conductors that form the rod-shaped coils disposed between the side close to the rotor and the side separated from the rotor can be made the same, a current resistance of the rod-shaped coil can be made constant. Accordingly, current flowing through the rod-shaped coil can be made constant. Accordingly, a magnetic force generated by the rod-shaped coil can be made constant to secure performance of the rotating electric machine.

(5) In the above-mentioned aspect, a segment pattern may be provided in which one segment formed by the slit of the plate conductor periodically changes positions with another neighboring segment or another diagonally neighboring segment.

According to this configuration, by providing the segment pattern in which one segment formed by the slit of the plate conductor periodically changes positions with another neighboring segment or another diagonally neighboring segment, the plate conductor can be divided. Accordingly, a slit length in the twisted state formed in the divided conductor can be reduced. Accordingly, the slit in the twisted state can be relatively easily formed in the plate conductor.

(6) In the above-mentioned aspect, the plate conductor may be formed such that changing positions of each segments starting from a starting point of the slit matches a segment pattern of the starting point at an ending point of the slit.

According to this configuration, changing positions of the segments starting from the starting point of the slit in the twisted state are matched at the ending point. Accordingly, by moving each segment by one circulation, the slits in the twisted state can be evenly distributed to the plate conductor. Accordingly, it is possible to minimize the coil eddy current loss uniformly and appropriately over the entire rod-shaped coil, and also minimize circulation loss.

(7) A method of manufacturing a rotating electric machine according to the present invention is a method of manufacturing the rotating electric machine of (1), including molding the plate conductor having the slit formed in the twisted state through metal lamination molding.

Here, it is conceivable that a structure of the plate conductor is complicated by increasing the number of slits in the twisted state formed in the plate conductor. Here, in the manufacturing method, the plate conductor is manufactured by the metal lamination molding. Accordingly, even when the number of slits in the twisted state is increased and the structure of the plate conductor is complicated, a machining process can be reduced compared to conventional electric discharge machining or mechanical machining. Accordingly, the plate conductor can be manufactured at a low cost.

(8) In the above-mentioned aspect, the rod-shaped coil including the plate conductor may be spirally continuous, and the rod-shaped coil may be molded integrally by metal lamination molding as a whole.

According to the manufacturing method, by integrally molding the entire rod-shaped coil including the plate conductor through the metal lamination molding, the molding process of the rod-shaped coil including the complicated plate conductor can be reduced compared to the conventional electric discharge machining or mechanical machining. Accordingly, productivity of the rod-shaped coil can be increased.

According to the aspect of the present invention, it is possible to effectively suppress the coil eddy current loss of the rod-shaped coil and contribute to energy efficiency.

### BRIEF DESCRIPTION OF THE DRAWINGS

FIG. 1 is an exploded perspective view showing a rotating electric machine of a first embodiment according to the present invention.

FIG. 2 is an exploded perspective view of a stator core assembly and a rotor of the rotating electric machine in the first embodiment.

FIG. 3 is a perspective view of a rod-shaped coil in the first embodiment.

FIG. 4 is a cross-sectional view showing the rotating electric machine of the first embodiment cut in a radial direction.

FIG. 5 is an enlarged perspective view of a portion V in FIG. 3, showing an area in which the rod-shaped coil is disposed on a rotor side.

FIG. 6 is a perspective view showing an area in which the rod-shaped coil in the first embodiment is disposed on a side separated from the rotor.

FIG. 7 is a perspective view showing a plate conductor disposed on a side separated from the rotor in the first embodiment.

FIG. 8A is a perspective view of a first part in the plate conductor disposed on the side separated from the rotor in the first embodiment.

FIG. 8B is a perspective view of a second part in the plate conductor disposed on the side separated from the rotor in the first embodiment.

FIG. 8C is a perspective view of a first conductor in the plate conductor disposed on the side separated from the rotor in the first embodiment.

FIG. 8D is a perspective view of a second conductor in the plate conductor disposed on the side separated from the rotor in the first embodiment.

FIG. 9 is a cross-sectional view showing a lower end portion in the plate conductor of FIG. 7, which is cut.

FIG. 10 shows cross-sectional views of the plate conductor of FIG. 7 taken along lines X (A)-X (A) to X (I)-X(I).

FIG. 11 is a perspective view showing the plate conductor disposed on the rotor side in the first embodiment.

FIG. 12A is a perspective view of a first part in the plate conductor disposed on the rotor side of the first embodiment.

FIG. 12B is a perspective view of a second part in the plate conductor disposed on the rotor side of the first embodiment.

FIG. 12C is a perspective view of a first conductor in the plate conductor disposed on the rotor side of the first embodiment.

FIG. 12D is a perspective view of a second conductor in the plate conductor disposed on the rotor side of the first embodiment.

FIG. 13 is a cross-sectional view of a lower end portion in the plate conductor of FIG. 11, which is cut.

FIG. 14 shows cross-sectional views of the plate conductor in FIG. 11 taken along lines XIV (A)-XIV (A) to XIV (M)-XIV (M).

FIG. 15 is a perspective view showing a plate conductor disposed on the rotor side in a variant.

FIG. 16 shows cross-sectional views of the plate conductor of FIG. 15 taken along lines XVI (A)-XVI (A) to XVI (O)-XIV (O).

FIG. 17 is an enlarged cross-sectional view of a segment pattern taken along line XVI (A)-XVI (A) of a second conductor of FIG. 16.

FIG. 18 is a perspective view showing a rod-shaped coil of a second embodiment according to the present invention.

FIG. 19 is a plan view showing the rod-shaped coil of FIG. 18 in a direction of an arrow XIX.

FIG. 20 is a cross-sectional view of the rod-shaped coil of FIG. 18 taken along line XX-XX.

FIG. 21 is a perspective view showing a plate conductor disposed on the rotor side in the second embodiment.

FIG. 22A is a perspective view of a first part in the plate conductor disposed on the rotor side of the second embodiment.

FIG. 22B is a perspective view of a second part in the plate conductor disposed on the rotor side of the second embodiment.

FIG. 22C is a perspective view of a third part in the plate conductor disposed on the rotor side of the second embodiment.

FIG. 22D is a perspective view of a third conductor in the plate conductor disposed on the rotor side of the second embodiment.

FIG. 22E is a perspective view of a fourth conductor in the plate conductor disposed on the rotor side of the second embodiment.

FIG. 22F is a perspective view of a fifth conductor in the plate conductor disposed on the rotor side of the second embodiment.

FIG. 22G is a perspective view of a first conductor in the plate conductor disposed on the rotor side of the second embodiment.

FIG. 22H is a perspective view of a second conductor in the plate conductor disposed on the rotor side of the second embodiment.

FIG. 23 shows cross-sectional views of the plate conductor of FIG. 21 taken along lines XXIII (A)-XXIII (A) to XXIII (I)-XXIII (I).

FIG. 24 is an exploded perspective view of a rotating electric machine of a variant according to the present invention.

### DETAILED DESCRIPTION OF THE INVENTION

Hereinafter, a rotating electric machine and a method of manufacturing the rotating electric machine according to an embodiment of the present invention will be described with reference to the accompanying drawings.

### First Embodiment

### <Rotating Electric Machine>

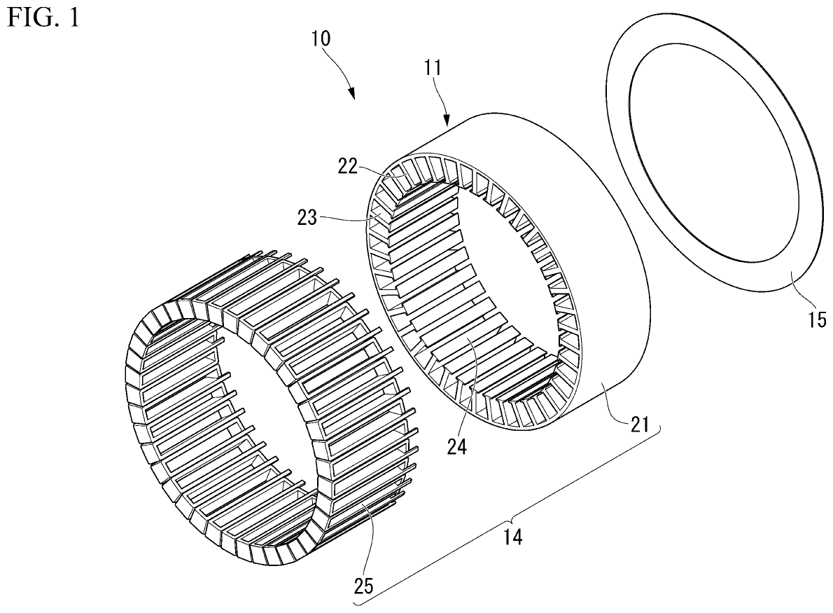

FIG. 1 is an exploded perspective view showing a rotating electric machine of a first embodiment.

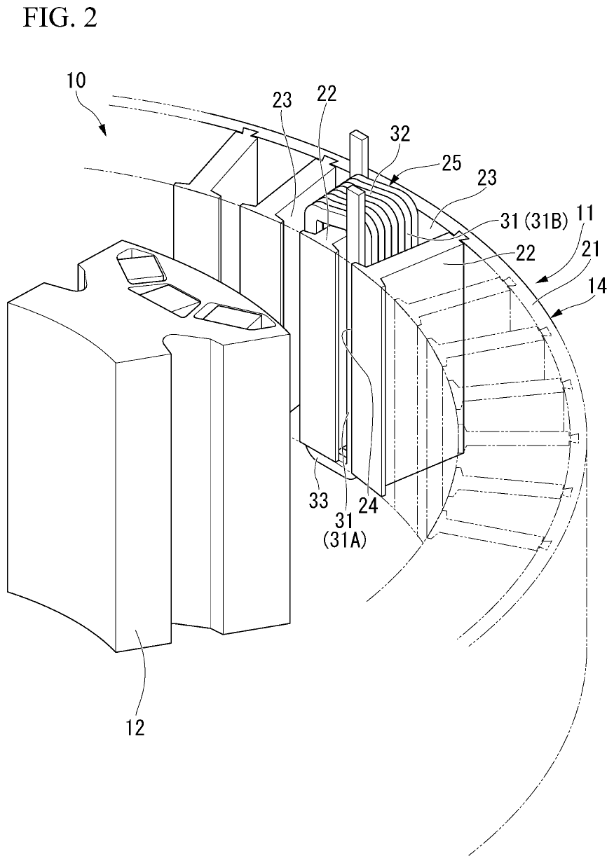

As shown in FIG. 1, a rotating electric machine 10 includes a stator 11 and a rotor 12 (see FIG. 2). The stator 11 includes a stator core assembly 14 and a base plate assembly 15. The base plate assembly 15 is attached to one side of the stator core assembly 14 via an insulating sheet (not shown). The stator core assembly 14 includes an annular stator core 21 and a plurality of rod-shaped coils 25.

The stator core 21 is constituted by, for example, stacking a plurality of pressed silicon sheets. The stator core 21 has a plurality of teeth 22 formed on an inner side in a radial direction, and a plurality of slots 23 formed between the neighboring teeth 22. The slots 23 are formed to pass through the stator core 21 in the axial direction, and an opening portion 24 is open in an inner circumferential surface of the stator core 21.

The rotor 12 is disposed in a center space of the stator core 21 and is rotatably provided adjacent to the inner circumferential surface of the stator core 21.

Hereinafter, an axial direction of the stator core 21 may be simply referred to as “an axial direction,” and a radial direction of the stator core 21 may be simply referred to as “a radial direction.” In addition, a circumferential direction of the stator core 21 may be simply referred to as “a circumferential direction.”

### <Rod-Shaped Coil>

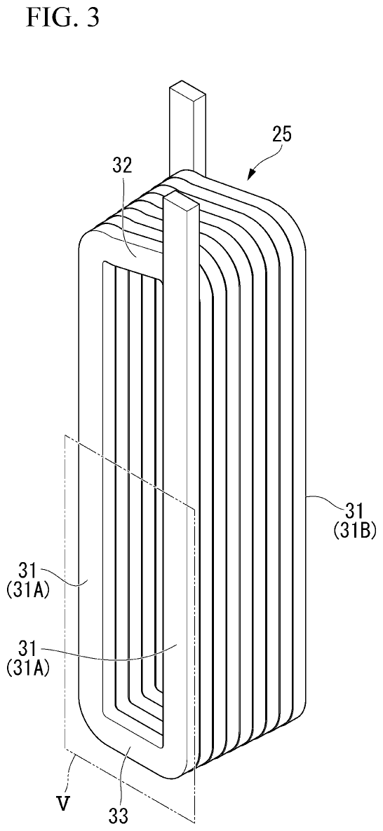

FIG. 2 is an exploded perspective view of a stator core assembly and a rotor of a rotating electric machine in the first embodiment. FIG. 3 is a perspective view of a rod-shaped coil in the first embodiment.

As shown in FIG. 2 and FIG. 3, the rod-shaped coils 25 are disposed (accommodated) in the slots 23. The rod-shaped coils 25 are connected by a connecting coil (not shown) provided in the base plate assembly 15 (see FIG. 1).

For example, the rod-shaped coils 25 are spirally continuously wound on the teeth 22 of the stator core 21. The rod-shaped coils 25 have a rectangular cross-sectional outline. The rod-shaped coils 25 include a plurality of plate conductors 31, a plurality of first crossover parts 32, and a plurality of second crossover parts 33.

The plurality of plate conductors 31 are disposed in the slots 23 formed on both sides of the teeth 22 in the circumferential direction. One ends of the plate conductors 31 disposed in the slots 23 on both sides are connected by the first crossover parts 32. The other ends of the plate conductors 31 disposed in the slots 23 on both sides are connected by the second crossover parts 33. As the plurality of plate conductors 31 are connected by the plurality of first crossover parts 32 and the plurality of second crossover parts 33, the rod-shaped coils 25 are formed in a spirally connected state.

### <Plate Conductor>

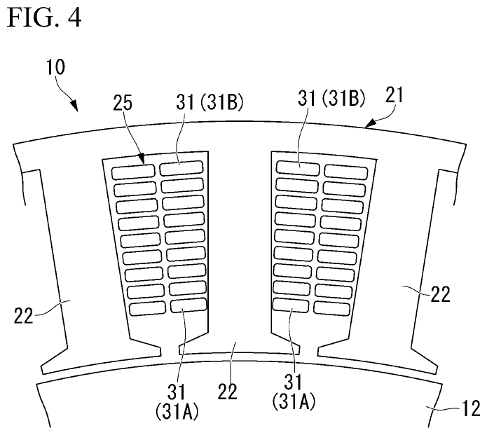

FIG. 4 is a cross-sectional view of the rotating electric machine of the first embodiment in the radial direction.

As shown in FIG. 4, the plurality of plate conductors 31 are arranged (disposed) in the slots 23 to overlap on the side of the rotor 12 from an outer circumferential side of the stator core 21. In addition, the outer circumferential side of the stator core 21 may be referred to as “a side separated from the rotor 12.” The plurality of plate conductors 31 are formed with a rectangular cross-sectional outline. Accordingly, wasted space in the slots 23 can be reduced and a space factor provided by the plate conductors 31 can be increased.

Here, increasing coil eddy current loss of the rod-shaped coils 25 by increasing the space factor by the plate conductors 31 is conceivable. Here, the coil eddy current loss is minimized by forming the slits in the plate conductors 31 in the twisted state (distorted state). The slits of the plate conductors 31 will be described below in detail.

In addition, the coil eddy current loss is generated more largely in the plate conductors 31 disposed on the side of the rotor 12 than the plate conductors 31 disposed on the side separated from the rotor 12. Here, the number of the slits of the plate conductors 31 disposed on the side of the rotor 12 is greater than the number of the slits of the plate conductors 31 disposed on the side separated from the rotor 12 to minimize the coil eddy current loss generated in the plate conductors 31 disposed on the side of the rotor 12.

Hereinafter, the plate conductors 31 disposed on the side of the rotor 12 may be referred to as “plate conductors 31A.” In addition, the plate conductors 31 disposed on the side separated from the rotor 12 may be referred to as “plate conductors 31B.”

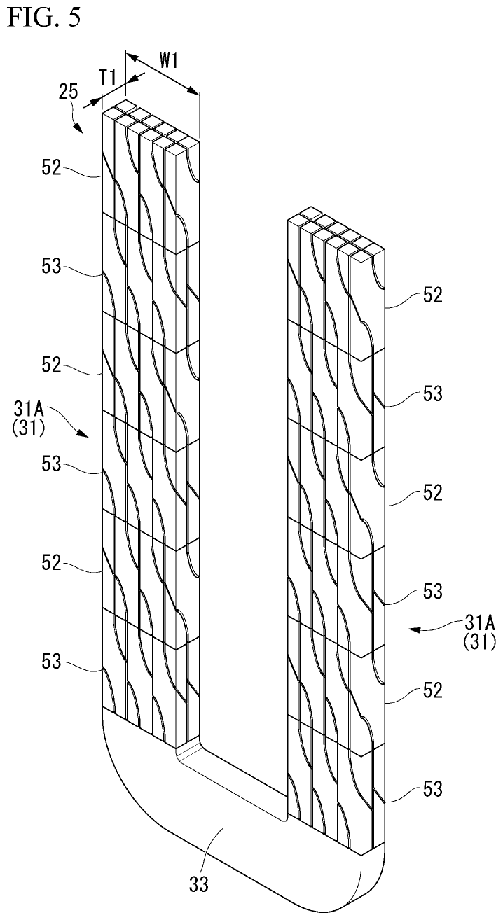

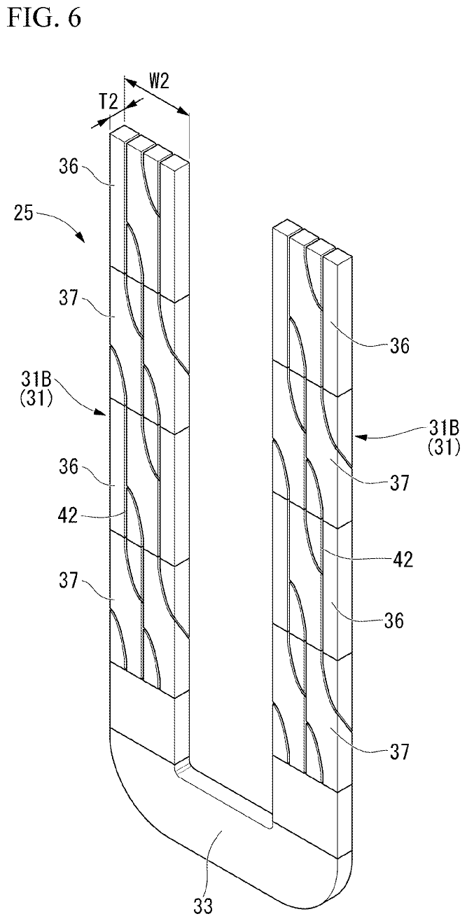

FIG. 5 is an enlarged perspective view of a portion V of FIG. 3, showing an area in which the rod-shaped coil is disposed on the rotor side. FIG. 6 is a perspective view showing an area in which the rod-shaped coil in the first embodiment is disposed on the side separated from the rotor.

As shown in FIG. 4 to FIG. 6, the plate conductor 31A disposed on the side of the rotor 12 is formed with a rectangular cross-sectional outline. The plate conductor 31A has a width W1 in the circumferential direction and a thickness T1 in the radial direction. The plate conductor 31B disposed on the side separated from the rotor 12 is formed with a rectangular cross-sectional outline. The plate conductor 31B has a width W2 in the circumferential direction and a thickness T2 in the radial direction. The width W1 of the plate conductor 31A is, for example, smaller than the width W2 of the plate conductor 31B. The thickness T1 of the plate conductor 31A is greater than the thickness T2 of the plate conductor 31B.

In addition, all the plate conductors 31 that form the rod-shaped coils 25 disposed between the side of the rotor 12 and the side separated from the rotor 12 are formed to have the same cross-sectional area. That is, the plate conductors 31A and the plate conductors 31B are formed to have the same cross-sectional area. Accordingly, the current resistance of the rod-shaped coils 25 can be kept constant. Accordingly, the current flowing through the rod-shaped coils 25 can be kept constant. Hereinafter, the plate conductors 31A disposed on the side of the rotor 12 and the plate conductors 31B disposed on the side separated from the rotor 12 will be described in detail.

<Plate Conductor Disposed on Side Separated from Rotor>

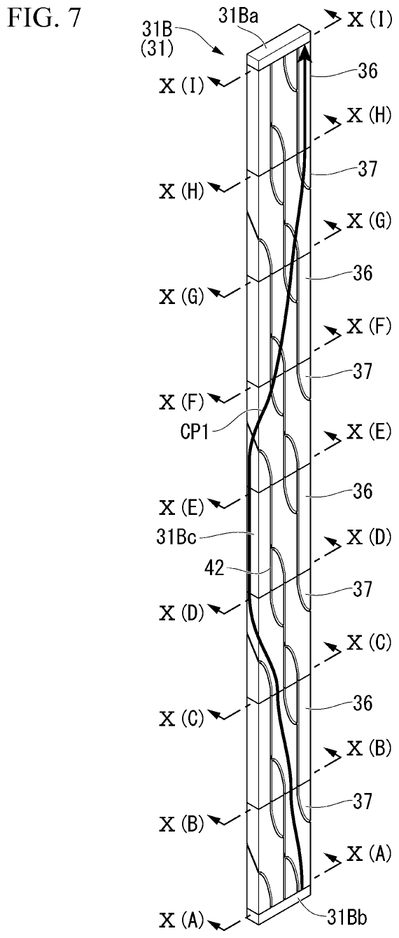

FIG. 7 is a perspective view showing a plate conductor disposed on the side separated from the rotor in the first embodiment.

As shown in FIG. 6 and FIG. 7, the plate conductor 31B disposed on the side separated from the rotor 12 (see FIG. 4) is formed by, for example, eight conductors from the side of one ends 31Ba toward the other ends 31Bb of the plate conductors 31B in the axial direction. Specifically, the eight conductors have four first conductors 36, and four second conductors 37.

The plate conductors 31B are continuously formed from the other ends 31Bb toward the one ends 31Ba in sequence of the second conductor 37, the first conductor 36, the second conductor 37, the first conductor 36, the second conductor 37, the first conductor 36, the second conductor 37, and the first conductor 36 in the axial direction. Further, the number of the plate conductors 31B divided in the axial direction is not limited to eight but may be set arbitrarily.

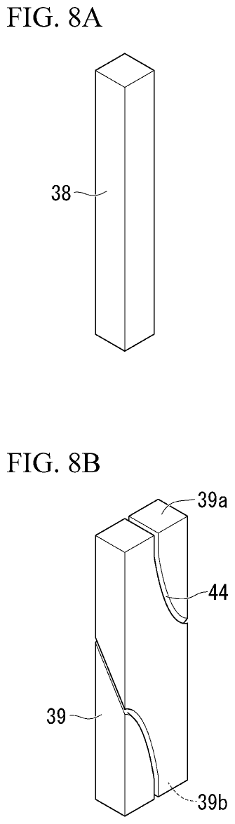

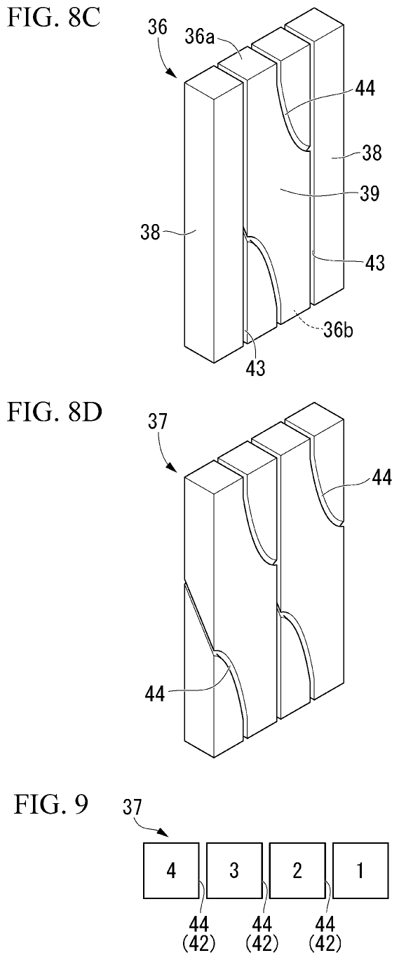

FIG. 8A is a perspective view of a first part in the plate conductor disposed on the side separated from the rotor of the first embodiment. FIG. 8B is a perspective view of a second part in the plate conductor disposed on the side separated from the rotor of the first embodiment. FIG. 8C is a perspective view of a first conductor in the plate conductor disposed on the side separated from the rotor of the first embodiment. FIG. 8D is a perspective view of a second conductor in the plate conductor disposed on the side separated from the rotor of the first embodiment.

As shown in FIG. 8A to FIG. 8D, the first conductor 36 has two first parts 38, and one second part 39. Specifically, in the first conductor 36, the second part 39 is disposed between the two first parts 38 in the circumferential direction.

For example, the first parts 38 are formed with a square cross-sectional outline and extend in the axial direction. A first slit 43 is linearly formed between the first parts 38 and the second part 39 from one end 36a to the other end 36b of the first conductors 36 in the axial direction. The first part 38 is divided into one segment by the first slit 43 with respect to the second part 39.

The second part 39 is formed in, for example, a rectangular shape in which a cross-sectional outline is elongated in the circumferential direction, and extends in the axial direction. A second slit 44 is formed in the second part 39 from one end 39a toward the other end 39b in a twisted state. The second part 39 is divided into two segments in the circumferential direction by the second slit 44 in the twisted state. The two segments in the second part 39 are formed with a square cross-sectional outline, for example, like the segment of the first parts 38. That is, the first conductor 36 is divided into four segments with a square cross-sectional outline by the first slit 43 and the second slit 44 in one row in the circumferential direction.

The second conductor 37 has the two second parts 39. The second part 39 is divided into two segments in the circumferential direction by the second slit 44 in the twisted state. Accordingly, the second conductor 37 is divided into four segments with a square cross-sectional outline by the second slit 44 in a row in the circumferential direction.

Further, the shape of the four segments formed in the first conductor 36 and the second conductor 37 is not limited to the square. In addition, segment patterns that divide the first conductors 36 and the second conductors 37 in the circumferential direction are not limited to four.

As shown in FIG. 7, FIG. 8C and FIG. 8D, in the plate conductor 31B, the second conductors 37 and the first conductors 36 are alternately continuously formed from the other end 31Bb to the one end 31Ba of the plate conductor 31B. In this state, the first slit 43 and the second slit 44 continue from the other end 31Bb to the one end 31Ba of the plate conductor 31B. A slit 42 is formed by the first slit 43 and the second slit 44, which are continuous. The slit 42 is formed in a twisted state from the one end 31Ba toward the other end 31Bb of the plate conductor 31B.

Here, the plate conductor 31B is formed by alternately and continuously combining the second conductors 37 and the first conductors 36. Accordingly, the number of twists of the slit 42 can be suitably adjusted in the range from the one end 31Ba to the other end 31Bb of the plate conductor 31B.

FIG. 9 is a cross-sectional view of a lower end portion in the plate conductor of FIG. 7, which is cut.

As shown in FIG. 7 to FIG. 9, the second conductors 37 have a first segment, a second segment, a third segment, and a fourth segment as four segments. In FIG. 9, the first segment is expressed as “1,” the second segment is expressed as “2,” the third segment is expressed as “3,” and the fourth segment is expressed as “4.”

The first segment, the second segment, the third segment, and the fourth segment of the second conductors 37 are disposed in sequence in a segment pattern extending from a right side of the drawing toward a left side of the drawing in the circumferential direction.

Here, the slit 42 is formed in the twisted state from the one end 31Ba toward the other end 31Bb of the plate conductor 31B. Accordingly, the segment pattern in which the first segment, the second segment, the third segment, and the fourth segment are disposed periodically change positions with each other in the circumferential direction from the other end 31Bb toward the one end 31Ba of the plate conductor 31B.

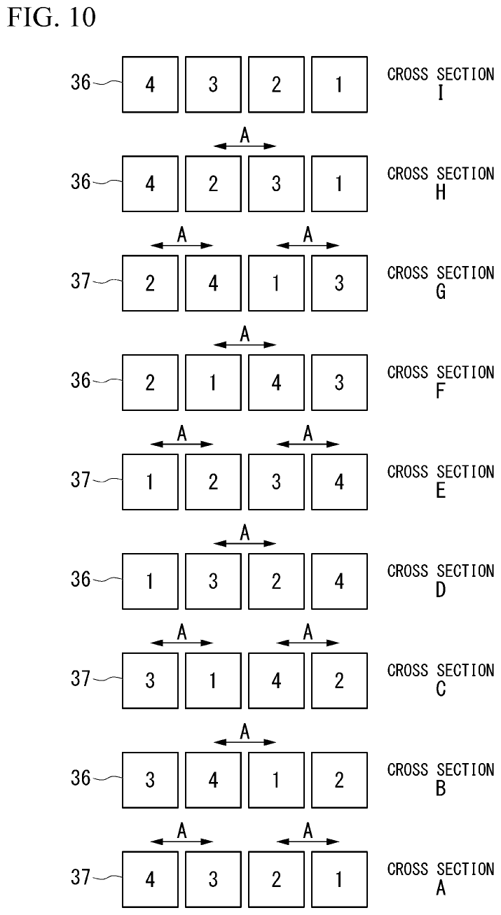

Next, an example in which the segment pattern of the plate conductor 31B periodically change positions with each other from the other end 31Bb toward the one end 31Ba of the plate conductor 31B will be described with reference to FIG. 7 and FIG. 10.

FIG. 10 shows cross-sectional views of the plate conductor of FIG. 7 taken along lines X (A)-X (A) to X (I)-X (I). Further, the cross-sectional view of the plate conductor of FIG. 10 taken along line X (A)-X (A) is the same as the cross-sectional view of FIG. 9. In FIG. 10, like FIG. 9, the first segment is expressed as “1,” the second segment is expressed as “2,” the third segment is expressed as “3,” and the fourth segment is expressed as “4.”

As shown in FIG. 7 and FIG. 10, in the segment pattern of the second conductor 37 and the first conductors 36 taken along lines X (A)-X (A) to X (I)-X (I) of the plate conductor 31B, the neighboring segments periodically change positions with each other like an arrow A in the circumferential direction.

Hereinafter, the segment pattern taken along lines X (A)-X (A) to X (I)-X (I) of the plate conductor 31B will be described in detail.

The segment pattern of the second conductor 37 taken along line X (A)-X (A) of the plate conductor 31B is disposed in sequence of the first segment, the second segment, the third segment, and the fourth segment from the right side of the drawing toward the left side of the drawing.

In the first segment, the second segment, the third segment, and the fourth segment, the neighboring segments in a place taken along line X (B)-X (B) of the plate conductor 31B periodically change positions with each other like an arrow A in the circumferential direction.

In the segment pattern of the first conductor 36 taken along line X (B)-X (B) of the plate conductor 31B, the second segment, the first segment, the fourth segment, and the third segment are disposed in sequence in the circumferential direction from the right side of the drawing toward the left side of the drawing.

The first segment and the fourth segment, which are neighboring each other, periodically change positions with each other like an arrow A in the circumferential direction in a place taken along line X (C)-X (C) of the plate conductor 31B.

In the segment pattern of the second conductor 37 taken along line X (C)-X (C) of the plate conductor 31B, the second segment, the fourth segment, the first segment, and the third segment are disposed in sequence in the circumferential direction from the right side of the drawing toward the left side of the drawing.

In the second segment, the fourth segment, the first segment, and the third segment, the neighboring segments in a place taken along line X (D)-X (D) of the plate conductor 31B periodically change positions with each other like an arrow A in the circumferential direction.

In the segment pattern of the first conductor 36 taken along line X (D)-X (D) of the plate conductor 31B, the fourth segment, the second segment, the third segment, and the first segment are disposed in sequence in the circumferential direction from the right side of the drawing toward the left side of the drawing.

The second segment and the third segment, which are neighboring each other, periodically change positions with each other like an arrow A in the circumferential direction in a place taken along line X (E)-X (E) of the plate conductor 31B.

In the segment pattern of the second conductor 37 taken along line X (E)-X (E) of the plate conductor 31B, the fourth segment, the third segment, the second segment, and the first segment are disposed in sequence in the circumferential direction from the right side of the drawing toward the left side of the drawing.

In the fourth segment, the third segment, the second segment, and the first segment, the neighboring segment in a place taken along line X (F)-X (F) of the plate conductor 31B periodically change positions with each other like an arrow A in the circumferential direction.

In the segment pattern of the first conductor 36 taken along line X (F)-X (F) of the plate conductor 31B, the third segment, the fourth segment, the first segment, and the second segment are disposed in sequence in the circumferential direction from the right side of the drawing toward the left side of the drawing.

The fourth segment and the first segment, which are neighboring each other, periodically change positions with each other like an arrow A in the circumferential direction in a place taken along line X (G)-X (G) of the plate conductor 31B.

In the segment pattern of the second conductor 37 taken along line X (G)-X (G) of the plate conductor 31B, the third segment, the first segment, the fourth segment, and the second segment are disposed in sequence in the circumferential direction from the right side of the drawing toward the left side of the drawing.

In the third segment, the first segment, the fourth segment, and the second segment, the neighboring segments in a place taken along line X (H)-X (H) of the plate conductor 31B periodically change positions with each other like an arrow A in the circumferential direction.

In the segment pattern of the first conductor 36 taken along line X (H)-X (H) of the plate conductor 31B, the first segment, the third segment, the second segment, and the fourth segment are disposed in sequence in the circumferential direction from the right side of the drawing toward the left side of the drawing.

The third segment and the second segment, which are neighboring each other, periodically change positions with each other like an arrow A in the circumferential direction in a place taken along line X (I)-X (I) of the plate conductor 31B.

In the segment pattern of the first conductor 36 taken along line X (I)-X (I) of the plate conductor 31B, the first segment, the second segment, the third segment, and the fourth segment are disposed in sequence in the circumferential direction from the right side of the drawing toward the left side of the drawing.

In this way, in the segment pattern of the first segment, the second segment, the third segment, and the fourth segment, the neighboring segments from the other end 31Bb toward the one end 31Ba of the plate conductor 31B periodically change positions with each other in the circumferential direction. That is, in the segment pattern, one segment periodically changes position with another neighboring segment. Accordingly, the first segment, the second segment, the third segment, and the fourth segment return to their original positions while moving from the other end 31Bb to the one end 31Ba of the plate conductor 31B. Accordingly, in the slit 42 of the plate conductor 31B, the position changing starting from the starting point (i.e., the other end 31Bb) matches the segment pattern of the starting point at the ending point (i.e., the one end 31Ba).

In FIG. 7 and FIG. 10, in a current path passing through the first segment, the second segment, the third segment, and the fourth segment periodically change positions with each other from the side of the rotor 12 (see FIG. 4), a current path CP1 passing through the first segment is shown as an arrow.

The current path CP1 passing through the first segment first passes through the right side of the drawing at the other end 31Bb of the plate conductor 31B. The current path CP1 passing through the other end 31Bb passes through the left side of the drawing at a center 31Bc of the plate conductor 31B. The current path CP1 passing through the center 31Bc passes through the right side of the drawing at the one end 31Ba of the plate conductor 31B. That is, the current path CP1 passes through the first segment with one cycle of twist from the other end 31Bb to the one end 31Ba of the plate conductor 31B.

The current path passing through the second segment, the third segment, and the fourth segment also passes through each of the segments with one cycle of twist from the other end 31Bb to the one end 31Ba of the plate conductor 31B like the current path CP1 passing through the first segment.

In this way, by forming the slit 42 from the one end 31Ba to the other end 31Bb of the plate conductor 31B in the twisted state, this periodic circular movement of the segment pattern allows the inter-linkage magnetic flux between the segments to be the same throughout the rod-shaped coils 25 (see FIG. 6). As a result, the induction voltage difference between the segments can be reduced, and the loss due to the circulating current (i.e., circulation loss) caused by the induction voltage difference can be minimized.

Further, by dividing and subdividing the plate conductors 31A (to be described below) and 31B using the slit 42 in the twisted state, the coil eddy current loss due to occurrence of the eddy current can also be minimized.

### <Plate Conductor Disposed on Rotor Side>

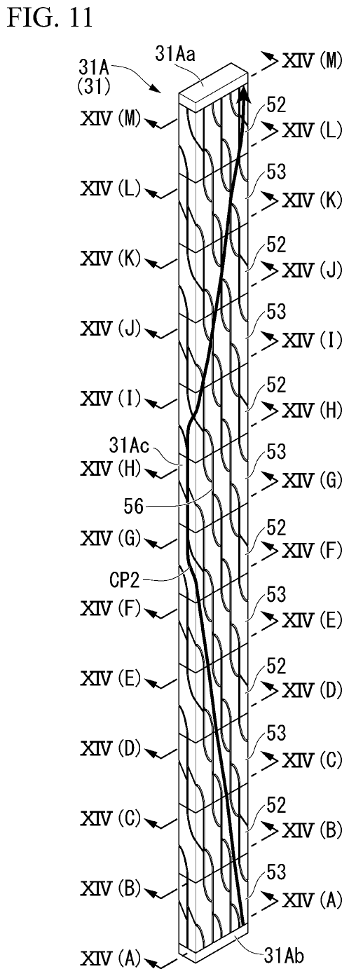

FIG. 11 is a perspective view showing the plate conductor disposed on the rotor side in the first embodiment. As shown in FIG. 4, FIG. 5 and FIG. 11, the plate conductor 31A disposed on the side of the rotor 12 is constituted by, for example, twelve conductors from the side of one end 31Aa to the side of the other end 31Ab of the plate conductor 31A in the axial direction. Specifically, the twelve conductors have six first conductors 52, and six second conductors 53.

The plate conductor 31A has the second conductor 53, the first conductor 52, the second conductor 53, the first conductor 52, the second conductor 53, the first conductor 52, the second conductor 53, the first conductor 52, the second conductor 53, the first conductor 52, the second conductor 53, and the first conductor 52, which are sequentially continuously formed from the other end 31Ab toward the one end 31Aa in the axial direction. Further, the number of parts into which the plate conductor 31A is divided in the axial direction is not limited to 12, but may be set arbitrarily.

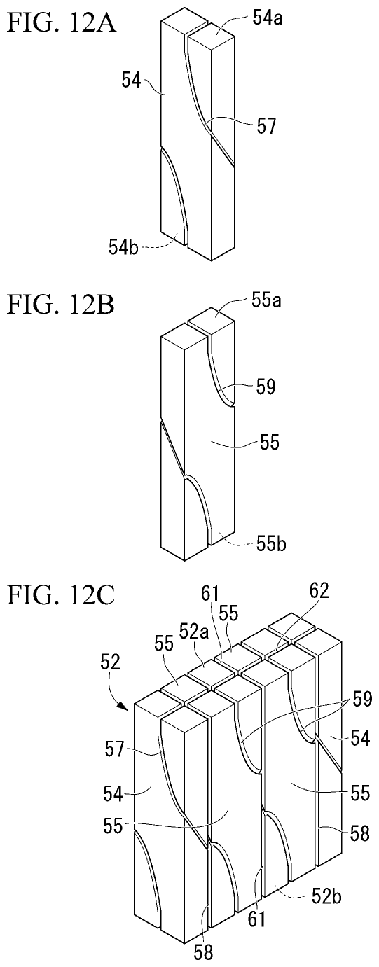

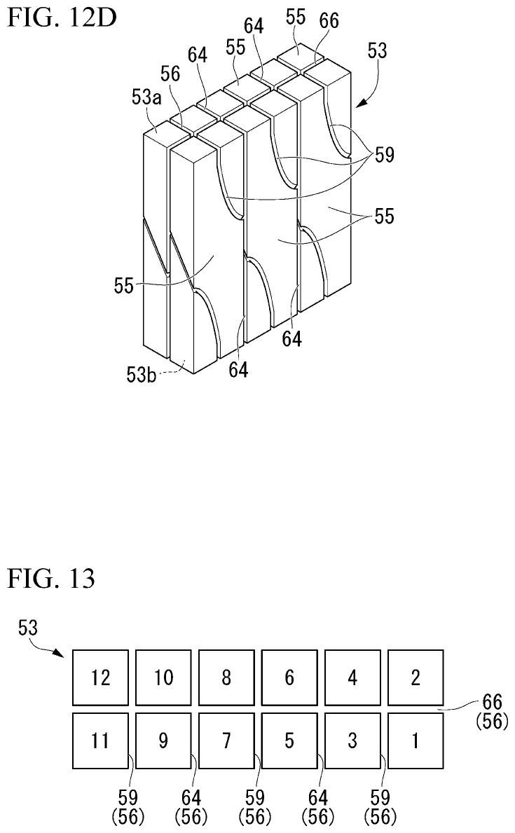

FIG. 12A is a perspective view of a first part in the plate conductor disposed on the rotor side of the first embodiment. FIG. 12B is a perspective view of a second part in the plate conductor disposed on the rotor side of the first embodiment. FIG. 12C is a perspective view of a first conductor in the plate conductor disposed on the rotor side of the first embodiment. FIG. 12D is a perspective view of a second conductor in the plate conductor disposed on the rotor side of the first embodiment.

As shown in FIG. 12A to FIG. 12D, the first conductor 52 has two first parts 54, and four second parts 55. Specifically, in the first conductor 52, the four second parts 55 are disposed between the two first parts 54 in the circumferential direction.

For example, the first part 54 is formed in a rectangular shape, a cross-sectional outline of which is elongated in the radial direction, and extends in the axial direction. A first slit 57 is formed in the first part 54 in a twisted state from one end 54a toward the other end 54b. In addition, a second slit 58 is linearly formed between the first part 54 and the second part 55 from one end 52a to the other end 52b of the first conductor 52 in the axial direction. The first part 54 is divided into two segments in the radial direction by the first slit 57 in a twisted state and the second slit 58 in a linear state. The two segments in the first part 54 are formed with, for example, a square cross-sectional outline.

For example, the second part 55 is formed in a rectangular shape, a cross-sectional outline of which is elongated in the circumferential direction, and extends in the axial direction. A third slit 59 is formed in the second part 55 in a twisted state from one end 55a toward the other end 55b. The second part 55 is divided into two segments in the circumferential direction by the third slit 59 in the twisted state. The two segments in the second part 55 are formed with, for example, a square cross-sectional outline like the segments of the first part 54.

In the first conductor 52, the two first parts 54 are disposed at an interval in the circumferential direction, and the four second parts 55 are disposed between the two first parts 54. Two of the four second parts 55 are disposed on an inner side in the radial direction, and the other two parts are disposed on an outer side in the radial direction.

The two second parts 55 disposed on the inner side in the radial direction are disposed in the circumferential direction to be arranged with the segments of the first part 54 on the inner side in the radial direction. A fourth slit 61 is linearly formed between the second part 55 and the second part 55 disposed on the inner side in the radial direction from the one end 52a to the other end 52b of the first conductor 52 in the axial direction.

The other two second parts 55 disposed on the outer side in the radial direction are disposed in the circumferential direction to be arranged with the segments of the first part 54 on the outer side in the radial direction. The fourth slit 61 is linearly formed between the second part 55 and the second part 55 disposed on the outer side in the radial direction from the one end 52a to the other end 52b of the first conductor 52 along the axial direction.

In the first conductor 52, a dividing slit 62 that extends in the circumferential direction and that divides the first conductor 52 into a plurality of layers (in the first embodiment, two layers) in the radial direction is formed. That is, the first conductor 52 is divided into two layers on an inner side and an outer side in the radial direction by the dividing slit 62. The first conductor 52 is not limited to two layers, but may be divided into three or more layers.

The first conductor 52 has the first slit 57 and the third slit 59 in the twisted state, and the second slit 58 and the fourth slit 61 in the linear state, in each of the divided two layers. In the first conductor 52, the two divided layers are each divided into six segments in the circumferential direction by the first slit 57, the second slit 58, the third slit 59, and the fourth slit 61.

That is, the first conductor 52 is divided into 12 segments with a square cross-sectional outline by the dividing slit 62, the first slit 57, the second slit 58, the third slit 59, and the fourth slit 61.

The second conductor 53 has the six second parts 55. The second part 55 is divided into two segments in the circumferential direction by the third slit 59 in the twisted state. In the six second parts 55, three parts are disposed on an inner side in the radial direction, and the other three parts are disposed on an outer side in the radial direction. A fifth slit 64 is linearly formed between the three second parts 55 disposed on the inner side in the radial direction from one end 53a to the other end 53b of the second conductor 53 along the axial direction. In addition, the fifth slit 64 is linearly formed between the three second parts 55 disposed on the outer side in the radial direction from the one end 53a to the other end 53b of the second conductor 53 along the axial direction.

The second conductor 53 is formed such that a dividing slit 66 extending in the circumferential direction divides the second conductor 52 into a plurality of layers (in the first embodiment, two layers) in the radial direction. That is, the second conductor 53 is divided into two layers on an inner side and an outer side in the radial direction by the dividing slit 66. The second conductor 53 is not limited to the two layers, but may be divided into three or more layers.

The second conductor 53 has the third slit 59 in the twisted state and the fifth slit 64 in the linear state in each of the divided two layers. In the second conductor 53, each of the divided two layers is divided into six segments in the circumferential direction by the third slit 59 and the fifth slit 64.

That is, the second conductor 53 is divided into 12 segments with a square cross-sectional outline by the dividing slit 66, the third slit 59, and the fifth slit 64.

Further, each shape of the 12 segments formed in the first conductor 52 and the second conductor 53 is not limited to the square. In addition, the segment pattern that divides the first conductor 52 and the second conductor 53 is not limited to 12. As shown in FIG. 11, FIG. 12C and FIG. 12D, the plate conductor 31A is configured by alternately and continuously forming the second conductors 53 and the first conductors 52. In this state, the first slit 57, the second slit 58, the third slit 59, the fourth slit 61, the fifth slit 64, and the dividing slits 62 and 66 are continuous from the one end 31Aa to the other end 31Ab of the plate conductor 31A. A slit 56 is formed by the first slit 57, the second slit 58, the third slit 59, the fourth slit 61, the fifth slit 64, and the dividing slits 62 and 66, which are continuous. The slit 56 is formed in a twisted state from the one end 31Aa toward the other end 31Ab of the plate conductor 31A.

The number of twists of the slit 56 from the one end 31Aa to the other end 31Ab of the plate conductor 31A can be appropriately adjusted as the plate conductor 31A is formed by alternately and continuously assembling the second conductors 53 and the first conductors 52.

Here, as the plate conductor 31A is divided into two layers by the dividing slits 62 and 66, the slit 56 independent from each layer can be formed in a twisted state. The slit 56 is formed by many slits such as the first slit 57, the second slit 58, the third slit 59, the fourth slit 61, the fifth slit 64, and the dividing slits 62 and 66. Accordingly, the slit 56 of the plate conductor 31A has a larger number of slits than the slit 42 of the plate conductor 31B (see FIG. 7).

FIG. 13 is a cross-sectional view of a lower end portion in the plate conductor of FIG. 11, which is cut.

As shown in FIG. 11 to FIG. 13, the second conductor 53 has a first segment, a second segment, a third segment, a fourth segment, a fifth segment, a sixth segment, a seventh segment, an eighth segment, a ninth segment, a tenth segment, an eleventh segment, and a twelfth segment, as 12 segments. In FIG. 13, the first segment is expressed as “1,” the second segment is expressed as 2,” the third segment is expressed as “3,” the fourth segment is expressed as “4,” the fifth segment is expressed as “5,” and the sixth segment is expressed as “6.” In addition, the seventh segment is expressed as “7,” the eighth segment is expressed as “8,” the ninth segment is expressed as “9,” the tenth segment is expressed as “10,” the eleventh segment is expressed as “11,” and the twelfth segment is expressed as “12.”

The first segment, the third segment, the fifth segment, the seventh segment, the ninth segment, and the eleventh segment are disposed inside the dividing slit 66 in the radial direction. The first segment, the third segment, the fifth segment, the seventh segment, the ninth segment, and the eleventh segment are sequentially disposed in a row in a segment pattern from the right side of the drawing toward the left side of the drawing in the circumferential direction.

The second segment, the fourth segment, the sixth segment, the eighth segment, the tenth segment, and the twelfth segment are disposed outside the dividing slit 66 in the radial direction. The second segment, the fourth segment, the sixth segment, the eighth segment, the tenth segment, and the twelfth segment are sequentially disposed in a row in a segment pattern from the right side of the drawing toward the left side of the drawing in the circumferential direction.

Here, the slit 56 of the plate conductor 31A is formed in a twisted state from the one end 31Aa toward the other end 31Ab of the plate conductor 31A. Accordingly, the segment pattern in which the first segment, the second segment, the third segment, the fourth segment, the fifth segment, the sixth segment, the seventh segment, the eighth segment, the ninth segment, the tenth segment, the eleventh segment, and the twelfth segment are disposed periodically change positions with each other in the circumferential direction from the other end 31Ab toward the one end 31Aa of the plate conductor 31A.

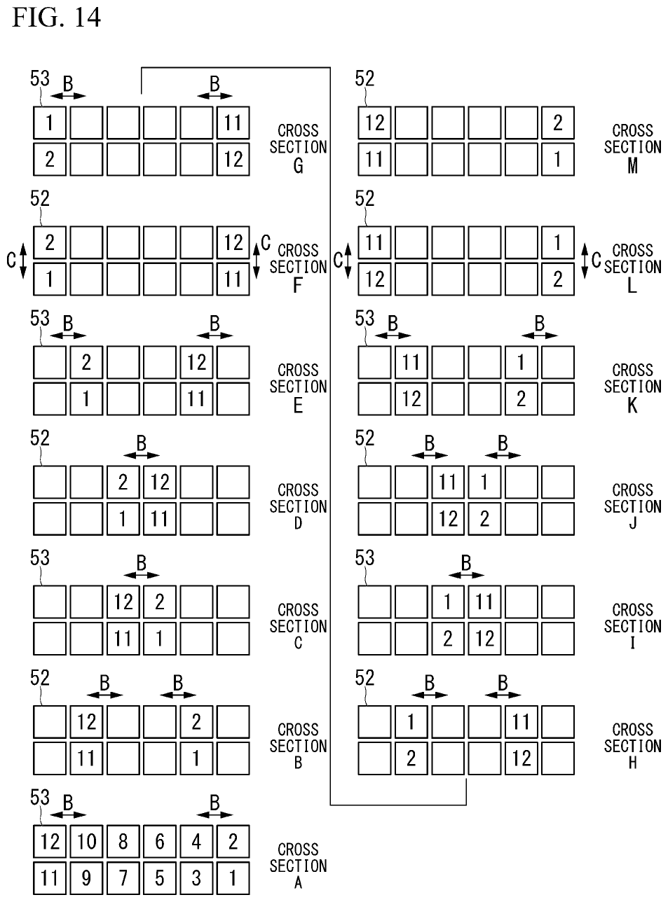

Next, an example in which the segment pattern of the plate conductor 31A periodically change positions with each other from the other end 31Ab toward the one end 31Aa of the plate conductor 31A will be described with reference to FIG. 11 and FIG. 14.

FIG. 14 shows cross-sectional views of the plate conductor of FIG. 11 taken along lines XIV (A)-XIV (A) to XIV (M)-XIV (M). Further, the cross-sectional view of the plate conductor of FIG. 14 taken along line XIV (A)-XIV (A) is the same as the cross-sectional view of FIG. 13. In FIG. 14, the first segment is expressed as “1,” the second segment is expressed as “2,” the third segment is expressed as “3,” the fourth segment is expressed as “4,” the fifth segment is expressed as “5,” and the sixth segment is expressed as “6.” In addition, the seventh segment is expressed as “7,” the eighth segment is expressed as “8,” the ninth segment is expressed as “9,” the tenth segment is expressed as “10,” the eleventh segment is expressed as “11,” and the twelfth segment is expressed as “12.”

As shown in FIG. 11 and FIG. 14, the segment patterns of the second conductor 53 and the first conductor 52 taken along lines XIV (A)-XIV (A) to XIV (M)-XIV (M) of the plate conductor 31A periodically change positions with each other. Specifically, in the segment pattern, the neighboring segments periodically change positions with each other like an arrow B in the circumferential direction, and further, the neighboring segments periodically change positions with each other like an arrow C in the radial direction.

Hereinafter, position changing of the segment patterns of the plate conductor 31A taken along lines XIV (A)-XIV (A) to XIV (M)-XIV (M) will be described in detail using the first segment, the second segment, the eleventh segment, and the twelfth segment as representative examples.

In the segment pattern of the second conductor 53 taken along line XIV (A)-XIV (A) of the plate conductor 31A, the first segment, the third segment, the fifth segment, the seventh segment, the ninth segment, and the eleventh segment are disposed in a row on an inner side in the radial direction from the right side of the drawing toward the left side of the drawing. In addition, in the segment pattern of the second conductor 53, the second segment, the fourth segment, the sixth segment, the eighth segment, the tenth segment, and the twelfth segment are disposed in a row on an outer side in the radial direction from the right side of the drawing toward the left side of the drawing.

In the first segment, the second segment, the eleventh segment, and the twelfth segment, the neighboring segments at a place taken along line XIV (B)-XIV (B) of the plate conductor 31A periodically change positions with each other like an arrow B in the circumferential direction.

In the segment pattern of the first conductor 52 taken along line XIV (B)-XIV (B) of the plate conductor 31A, the first segment and the eleventh segment are disposed closer to each other, and the second segment and the twelfth segment are disposed closer to each other.

In the first segment, the second segment, the eleventh segment, and the twelfth segment, the neighboring segments at a place taken along line XIV (C)-XIV (C) of the plate conductor 31A periodically change positions with each other like an arrow B in the circumferential direction.

In the segment pattern of the second conductor 53 taken along line XIV (C)-XIV (C) of the plate conductor 31A, the first segment and the eleventh segment are disposed closer to each other, and the second segment and the twelfth segment are disposed closer to each other.

In the first segment, the second segment, the eleventh segment, and the twelfth segment, the neighboring segments at a place taken along line XIV (D)-XIV (D) of the plate conductor 31A periodically change positions with each other like an arrow B in the circumferential direction.

In the segment pattern of the first conductor 52 taken along line XIV (D)-XIV (D) of the plate conductor 31A, the first segment and the eleventh segment are disposed at positions which switch positions with each other, and the second segment and the twelfth segment are disposed at positions which switch positions with each other.

In the first segment, the second segment, the eleventh segment, and the twelfth segment, the neighboring segments at a place taken along line XIV (E)-XIV (E) of the plate conductor 31A periodically change positions with each other like an arrow B in the circumferential direction.

In the segment pattern of the second conductor 53 taken along line XIV (E)-XIV (E) of the plate conductor 31B, the first segment and the eleventh segment are disposed at positions which separates from each other, and the second segment and the twelfth segment are disposed at positions which separates from each other.

In the first segment, the second segment, the eleventh segment, and the twelfth segment, the neighboring segments at a place taken along line XIV (F)-XIV (F) of the plate conductor 31A periodically change positions with each other like an arrow B in the circumferential direction.

In the segment pattern of the first conductor 52 taken along line XIV (F)-XIV (F) of the plate conductor 31A, the first segment and the eleventh segment are disposed at positions further separated from each other, and the second segment and the twelfth segment are disposed at positions further separated from each other.

In the first segment, the second segment, the eleventh segment, and the twelfth segment, the neighboring segments at a place taken along line XIV (G)-XIV (G) of the plate conductor 31A periodically change positions with each other like an arrow C in the radial direction.

In the segment pattern of the second conductor 53 taken along line XIV (G)-XIV (G) of the plate conductor 31A, the first segment and the second segment are disposed at positions that change positions with each other in the radial direction, and the eleventh segment and the twelfth segment are disposed at positions that change positions with each other in the radial direction.

In the first segment, the second segment, the eleventh segment, and the twelfth segment, the neighboring segments at a place taken along line XIV (H)-XIV (H) of the plate conductor 31A periodically change positions with each other like arrow B in the circumferential direction.

In the segment pattern of the first conductor 52 taken along line XIV (H)-XIV (H) of the plate conductor 31B, the second segment and the twelfth segment are disposed closer to each other, and the first segment and the eleventh segment are disposed closer to each other.

In the first segment, the second segment, the eleventh segment, and the twelfth segment, the neighboring segments at a place taken along line XIV (I)-XIV (I) of the plate conductor 31A periodically change positions with each other like an arrow B in the circumferential direction.

In the segment pattern of the second conductor 53 taken along line XIV (I)-XIV (I) of the plate conductor 31A, the second segment and the twelfth segment are disposed next to each other, and the first segment and the eleventh segment are disposed next to each other.

In the first segment, the second segment, the eleventh segment, and the twelfth segment, the neighboring segments at a place taken along line XIV (J)-XIV (J) of the plate conductor 31A periodically change positions with each other like an arrow B in the circumferential direction.

In the segment pattern of the first conductor 52 taken along line XIV (J)-XIV (J) of the plate conductor 31A, the second segment and the twelfth segment are disposed at positions that change positions with each other, and the first segment and the eleventh segment are disposed at positions that change position with each other.

In the first segment, the second segment, the eleventh segment, and the twelfth segment, the neighboring segments at a place taken along line XIV (K)-XIV (K) of the plate conductor 31A periodically change positions with each other like an arrow B in the circumferential direction.

In the segment pattern of the second conductor 53 taken along line XIV (K)-XIV (K) of the plate conductor 31A, the second segment and the twelfth segment are disposed at positions separated from each other, and the first segment and the eleventh segment are disposed at positions separated from each other.

In the first segment, the second segment, the eleventh segment, and the twelfth segment, the neighboring segments at a place taken along line XIV (L)-XIV (L) of the plate conductor 31A periodically change positions with each other like an arrow B in the circumferential direction.

In the segment pattern of the first conductor 52 taken along line XIV (L)-XIV (L) of the plate conductor 31A, the second segment and the twelfth segment are disposed at positions further separated from each other, and the first segment and the eleventh segment are disposed at positions further separated from each other.

In the first segment, the second segment, the eleventh segment, and the twelfth segment, the neighboring segments at a place taken along line XIV (M)-XIV (M) of the plate conductor 31A periodically change positions with each other like an arrow C in the radial direction.

In the segment pattern of the first conductor 52 taken along line XIV (M)-XIV (M) of the plate conductor 31A, the first segment and the second segment are disposed at positions that replace each other in the radial direction, and the eleventh segment and the twelfth segment are disposed at positions that replace each other in the radial direction.

In FIG. 11 and FIG. 14, among a current path which passes through the first segment, the second segment, the eleventh segment, the twelfth segment, and the like, which periodically change positions with each other, from the side of the rotor 12 (see FIG. 4), a current path CP2 passing through the first segment is shown by an arrow.

The current path CP2 passing through the first segment first passes through the right side of the drawing at the other end 31Ab of the plate conductor 31A. The current path CP2 passing through the other end 31Ab passes through the left side of the drawing at a center 31Ac of the plate conductor 31A. The current path CP2 passing through the center 31Ac passes through the right side of the drawing at the one end 31Aa of the plate conductor 31A. That is, the current path CP2 passes through the first segment with one cycle of twist from the other end 31Ab to the one end 31Aa of the plate conductor 31A. The current path passing through the second segment, the eleventh segment, the twelfth segment, and the like, also passes through each segment with one cycle of twist from the other end 31Ab to the one end 31Aa of the plate conductor 31A like the current path CP2 passing through the first segment.

In this way, by forming the slit 56 in the twisted state from the one end 31Aa to the other end 31Ab of the plate conductor 31A, the periodic circular movement of the segment pattern allows the inter-linkage magnetic flux between the segments to be the same throughout the rod-shaped coils 25 (see FIG. 5). As a result, the induction voltage difference between the segments can be reduced, and loss due to circulating current (i.e., circulation loss) caused by the induction voltage difference can be minimized.

Further, the plate conductors 31A and 31B (the plate conductor 31B shown in FIG. 7 is divided by the slit 42) are divided and subdivided by the slit 56 in the twisted state, and thus, the coil eddy current loss caused by occurrence of eddy current can be minimized.

Here, greater coil eddy current loss is generated in the plate conductor 31A disposed on the side of the rotor 12 than in the plate conductor 31B disposed on the side separated from the rotor 12. Here, the number of the slits of the slit 56 provided in the plate conductor 31A is greater than the number of the slits of the slit 42 (see FIG. 7) provided in the plate conductor 31B. Accordingly, the coil eddy current loss generated in the plate conductor 31A can be appropriately minimized.

Next, an example of manufacturing the rod-shaped coil 25 shown in FIG. 3 using a method of manufacturing the rotating electric machine 10 will be described.

As shown in FIG. 3, the rod-shaped coil 25 including the plate conductor 31 is formed through molding by a metal lamination molding method. The metal lamination molding method is manufactured by molding the rod-shaped coil 25 using a metal, for example, using a metal 3-dimensional printer (metal 3D printer). The metal 3D printer designs, for example, 3D data (3-dimensional data) of the rod-shaped coil 25 on a computer, and the rod-shaped coil 25 is integrally formed by repeating a process of laminating a metal material layer by layer on the basis of the designed 3D data.

According to the metal 3D printer, the plate conductor 31 having the slit 42 (see FIG. 7) and the slit 56 (see FIG. 11) formed in the twisted state is integrally formed by repeating a process of laminating a metal material layer by layer on the basis of the designed 3D data.

As described above, according to the rotating electric machine 10 of the first embodiment, as shown in FIG. 4, FIG. 7 and FIG. 11, the slit 42 is formed in the plate conductor 31B disposed on the side separated from the rotor 12 in the twisted state from the side of the one end 31Ba toward the other end 31Bb. Accordingly, the eddy current generated in the plate conductor 31B can be divided by the slit 42. Accordingly, occurrence of the coil eddy current loss in the plate conductor 31B can be more appropriately suppressed.

Here, the plate conductor 31A disposed on the side of the rotor 12 is greatly affected by the coil eddy current loss. Here, the number of the slits of the slit 56 provided in the plate conductor 31A is greater than the number of the slits of the slit 42 (see FIG. 7) provided in the plate conductor 31B. Accordingly, in the plate conductor 31A, a large eddy current can be divided into smaller eddy currents by the slit 56. Accordingly, occurrence of the coil eddy current loss in the plate conductor 31A can be suppressed.

Accordingly, in a state in which the rod-shaped coil 25 including the plate conductor 31A or the plate conductor 31B is spirally wound on the teeth 22 of the stator core 21, the coil eddy current loss generated in the rod-shaped coil 25 can be appropriately minimized, and it can contribute to energy efficiency.

In addition, by forming the slit 42 in the twisted state from the one end 31Ba to the other end 31Bb of the plate conductor 31B in the axial direction, an induction voltage difference between the segments of the plate conductor 31B can be reduced. Accordingly, the loss by the circulating current flowing through the plate conductor 31B (circulation loss) can be divided and reduced by the slit 42 in the twisted state.

Further, by forming the slit 56 in the twisted state from the one end 31Aa to the other end 31Ab of the plate conductor 31A in the axial direction, the induction voltage difference between the segments of the plate conductor 31A can be reduced. Accordingly, the loss by the circulating current flowing through the plate conductor 31A (circulation loss) can be divided and reduced by the slit 56 in the twisted state.

In addition, the thickness T1 of the plate conductor 31A is greater than the thickness T2 of the plate conductor 31B. Accordingly, a cross-sectional area of the plate conductor 31A can be increased. Accordingly, a range can be secured in which a large number of slits 56 are formed in the plate conductor 31A disposed on the side of the rotor 12 in the twisted state.

Further, by dividing the plate conductor 31A into two layers using the dividing slits 62 and 66 (see FIGS. 12A to 12D), the slit 56 independent from each layer can be formed in the twisted state. Accordingly, a range can be secured in which a large number of slits 56 are formed in the plate conductor 31A in the twisted state.

In addition, as shown in FIG. 3 and FIG. 4, cross-sectional areas of all the plate conductors 31 that form the rod-shaped coils 25 disposed between the side of the rotor 12 and the side separated from the rotor 12 are made the same. Accordingly, the current resistance of the rod-shaped coils 25 can be made constant, and the current flowing through the rod-shaped coils 25 can be made constant. Accordingly, a magnetic force generated by the rod-shaped coils 25 can be made constant to secure performance of the rotating electric machine 10.

In addition, as shown in FIG. 11 and FIG. 14, a segment pattern is provided in which one segment formed by the slit 56 of the plate conductor 31A is periodically changed position with another neighboring segment. Accordingly, for example, the plate conductor 31A can be formed by a combination of the first conductors 52 and the second conductors 53. Accordingly, a slit length in the twisted state formed in the first conductor 52 and the second conductor 53 can be reduced. Accordingly, the slit 56 in the plate conductor 31A can be relatively easily formed in the twisted state.

Further, as shown in FIG. 7 and FIG. 10, a segment pattern is provided in which one segment formed by the slit 42 of the plate conductor 31B is periodically changed position with another neighboring segment. Accordingly, for example, the plate conductor 31B can be formed by a combination of the first conductors 36 and the second conductors 37. Accordingly, a slit length in the twisted state formed in the first conductors 36 and the second conductors 37 can be reduced. Accordingly, the slit 42 in the plate conductor 31B can be relatively easily formed in the twisted state.

In addition, as shown in FIG. 7 and FIG. 11, the plate conductor 31A makes each segment positions starting from the starting point of the slit 56 in the twisted state match at the ending point. Accordingly, by moving each segment by one circulation, the slit 56 in the twisted state can be evenly distributed to the plate conductor 31A. As the plate conductor 31A is divided and subdivided by the slit 56 in the twisted state, the coil eddy current loss caused by occurrence of the eddy current can be minimized

Further, the plate conductor 31B makes each segment positions starting from the starting point of the slit 42 in the twisted state match at the ending point. Accordingly, by moving each segment by one circulation, the slit 42 in the twisted state can be evenly distributed. As the plate conductor 31B is divided and subdivided by the slit 42 in the twisted state, the coil eddy current loss caused by occurrence of the eddy current can be minimized.

Accordingly, the inter-linkage magnetic flux between the segments is made the same to eliminate the difference in induced voltage between the segments, and thus, the circulating current caused by the induced voltage can be eliminated. The inter-linkage magnetic flux between the segments can be made the same throughout all the rod-shaped coils 25 by the circular movement of the segment pattern to reduce the induction voltage difference between the segments, and the loss due to the circulating current caused by the induction voltage difference (i.e., circulation loss) can be minimized.

As described above, according to the method of manufacturing the rotating electric machine 10 of the first embodiment, as shown in FIG. 3, FIG. 7 and FIG. 11, the following effects are obtained.

Here, it is conceivable that the structure of the plate conductor 31A or the plate conductor 31B becomes complicated by increasing the number of slits in the slit 56 in the twisted state formed in the plate conductor 31A or the slit 42 in the twisted state formed in the plate conductor 31B. Here, in the method of manufacturing the rotating electric machine 10, the plate conductor 31A and the plate conductor 31B are manufactured by a metal lamination molding method using a metal 3D printer.

Accordingly, even when a structure of the plate conductor 31A in which the number of slots in the slit 56 in the twisted state is increased or the plate conductor 31B in which the number of slits in the slit 42 in the twisted state is increased is complicated, the machining process can be reduced compared to the conventional electric discharge machining or mechanical machining. Accordingly, the plate conductor 31A and the plate conductor 31B can be manufactured at a low cost.

In addition, all the rod-shaped coils 25 including the plate conductors 31A and the plate conductors 31B are manufactured by the metal lamination molding method using the metal 3D printer. Accordingly, the molding process of the rod-shaped coils 25 including the plate conductors 31A and the plate conductors 31B, which are complicated, can be reduced compared to the conventional electric discharge machining or mechanical machining. Accordingly, productivity of the rod-shaped coils 25 can be increased.

### (Variant)

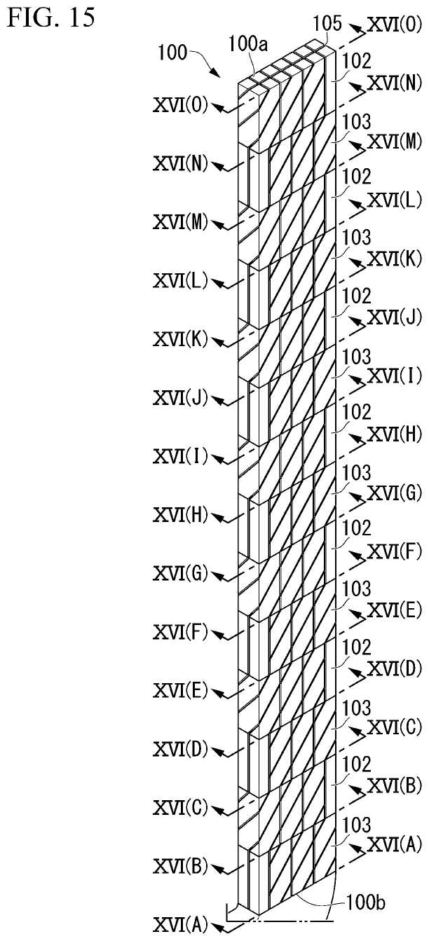

Next, a variant of the plate conductor 31A in the first embodiment will be described with reference to FIG. 15 to FIG. 17. Further, the same or similar members in a plate conductor 100 of the variant as in the first embodiment are designated by the same reference signs and detailed description thereof will be omitted.

FIG. 15 is a perspective view showing the plate conductor disposed on a rotor side in the variant.

As shown in FIG. 15, the plate conductor 100 of the variant is disposed on the side of the rotor 12 (see FIG. 4). The plate conductor 100 is formed by, for example, 14 conductors from the side of one end 100a toward other end 100b of the plate conductor 100 in the axial direction. Specifically, the 14 conductors have seven first conductors 102, and seven second conductors 103.

Like the plate conductor 31A of the first embodiment, in the plate conductor 100, the second conductors 103 and the first conductors 102 are sequentially, alternately and continuously formed from the other end 100b toward the one end 100a in the axial direction. The first conductors 102 and the second conductors 103 are formed such that a dividing slit 105 divided into a plurality of layers (in the variant, two layers) in the radial direction extends in the circumferential direction. For example, the first conductors 102 and the second conductors 103 are divided into, for example, seven segments in the circumferential direction. The first conductors 102 and the second conductors 103 are not limited to two layers but may be divided into three or more layers.

Next, an example in which the segment pattern of the plate conductor 100 is periodically replaced from the other end 100b toward the one end 100a of the plate conductor 100 will be described with reference to FIG. 15 to FIG. 17.

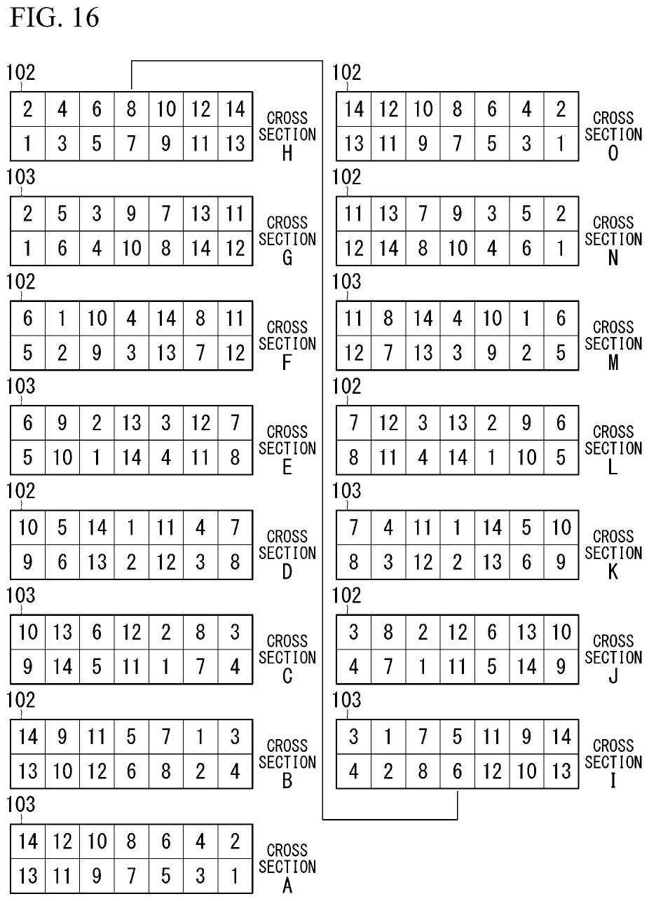

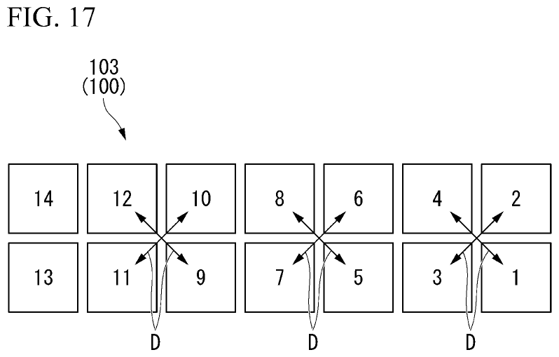

FIG. 16 shows cross-sectional views of the plate conductor of FIG. 15 taken along lines XVI (A)-XVI (A) to XVI (O)-XIV (O). FIG. 17 is an enlarged cross-sectional view of the segment pattern taken along line XVI (A)-XVI (A) of the second conductor in FIG. 16.

In FIG. 16 and FIG. 17, a first segment is expressed as “1,” a second segment is expressed as “2,” a third segment is expressed as “3,” a fourth segment is expressed as “4,” a fifth segment is expressed as “5,” a sixth segment is expressed as “6,” a seventh segment is expressed as “7.” In addition, an eighth segment is expressed as “8,” a ninth segment is expressed as “9,” a tenth segment is expressed as “10,” an eleventh segment is expressed as “11,” a twelfth segment is expressed as “12,” a thirteenth segment is expressed as “13,” and a fourteenth segment is expressed as “14.”

As shown in FIG. 15 to FIG. 17, in the segment pattern of the second conductors 103 and the first conductors 102 taken along lines XVI (A)-XVI (A) to XVI (O)-XVI (O) of the plate conductor 100, one segment is periodically diagonally replaced with another neighboring segment like an arrow D.

Hereinafter, position changes of the segment pattern will be described in detail using the segment pattern taken along line XVI (A)-XVI (A) of the plate conductor 100 as a representative example.

In the segment pattern of the second conductor 103 taken along line XVI (A)-XVI (A) of the plate conductor 100, the first segment, the third segment, the fifth segment, the seventh segment, the ninth segment, the eleventh segment, and the thirteenth segment are disposed on an inner side in the radial direction in a row from the right side of the drawing toward the left side of the drawing. In addition, in the segment pattern of the second conductor 103, the second segment, the fourth segment, the sixth segment, the eighth segment the, tenth segment, the twelfth segment, and the fourteenth segment are disposed on an outer side in the radial direction in a row from the right side of the drawing toward the left side of the drawing.

The diagonally neighboring first segment and fourth segment periodically change positions with each other like an arrow D. The diagonally neighboring second segment and third segment periodically change positions with each other like an arrow D. The diagonally neighboring fifth segment and eighth segment periodically change positions with each other like an arrow D. The diagonally neighboring sixth segment and seventh segment periodically change positions with each other like an arrow D. The diagonally neighboring ninth segment and twelfth segment periodically change positions with each other like an arrow D. The diagonally neighboring tenth segment and eleventh segment periodically change positions with each other like an arrow D. That is, in the segment pattern of the second conductor 103, one segment periodically changes postion with the other diagonally neighboring segment like the arrow D.

Even in the segment pattern of the second conductor 103 and the first conductor 102 taken along lines XVI (B)-XVI (B) to XVI (O)-XVI (O) of the plate conductor 100, one segment periodically changes position with the other diagonally neighboring segment like the arrow D.

Accordingly, in the first segment to the fourteenth segment, the slit of the plate conductor 100 makes positions of the segments starting from the starting point (i.e., the other end 100b) match the segment pattern of the starting point at the ending point (i.e., the one end 100a). Accordingly, the current path passes through the first segment with one cycle of twist from the other end 100b to the one end 100a of the plate conductor 100.

As described above, according to the plate conductor 100 of the variant, the same effects as the plate conductor 31A of the first embodiment can be obtained.

### Second Embodiment

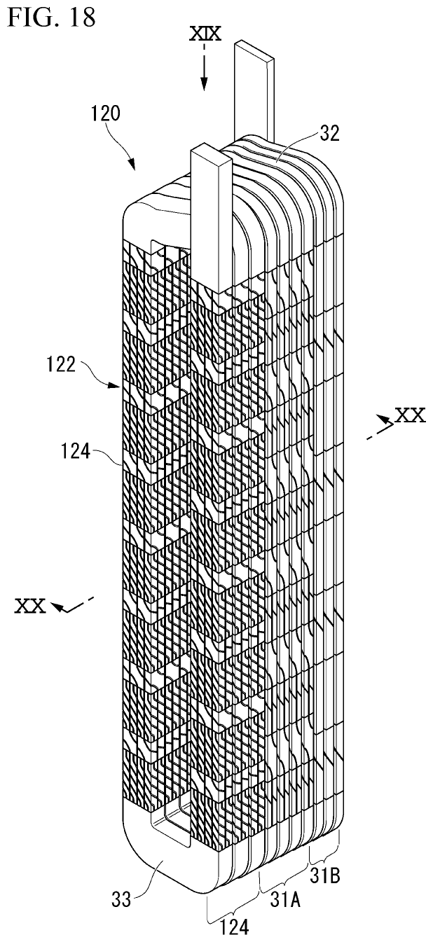

Next, a second embodiment of the rod-shaped coil 25 according to the first embodiment will be described with reference to FIG. 18 to FIG. 23. Further, the same or similar configurations or methods in a rod-shaped coil 120 of the second embodiment as in the first embodiment are designated by the same reference signs and detailed description thereof will be omitted.

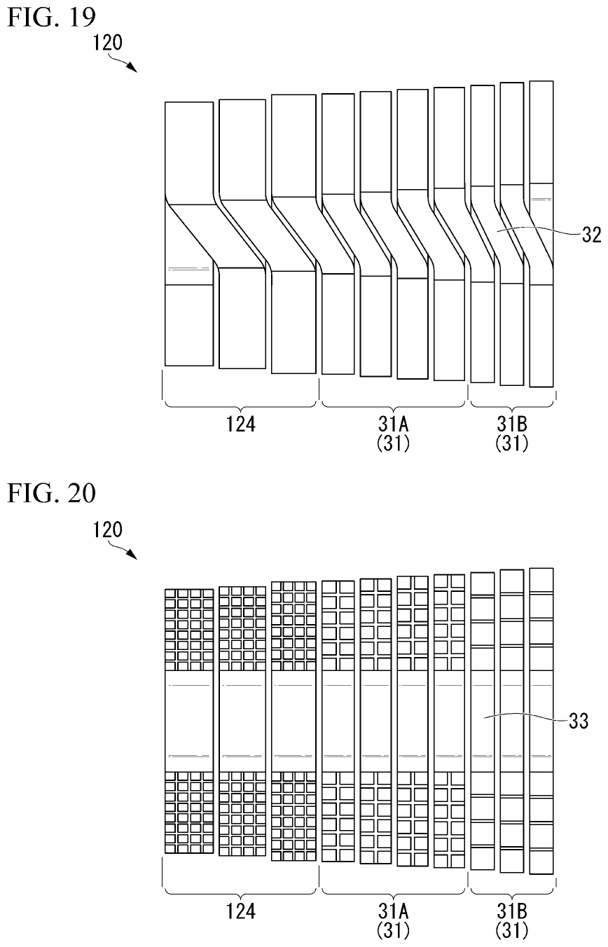

FIG. 18 is a perspective view showing the rod-shaped coil in the second embodiment. FIG. 19 is a plan view of the rod-shaped coil of FIG. 18 in a direction of an arrow XIX. FIG. 20 is a cross-sectional view of the rod-shaped coil of FIG. 18 taken along line XX-XX.

As shown in FIG. 18 to FIG. 20, the rod-shaped coil 120 in the second embodiment is obtained by continuously adding, for example, a second rod-shaped coil 122 to the rod-shaped coil 25 (see FIG. 3) in the first embodiment. The second rod-shaped coil 122 is disposed on the side of the rotor 12 (see FIG. 4). The second rod-shaped coil 122 includes a plurality of plate conductors 124. That is, the rod-shaped coil 120 includes the plurality of plate conductors 124, the plurality of plate conductors 31A, and the plurality of plate conductors 31B.

The plurality of plate conductors 124 are disposed on the side of the rotor 12. The plurality of plate conductors 31A are disposed on the side separated from the rotor 12 with respect to the plurality of plate conductors 124. The plurality of plate conductors 31B are disposed on the side separated from the rotor 12 with respect to the plurality of plate conductors 31A. The plate conductors 31A and the plate conductors 31B are the same as the plate conductors of the first embodiment. Hereinafter, the plate conductor 124 will be described in detail.

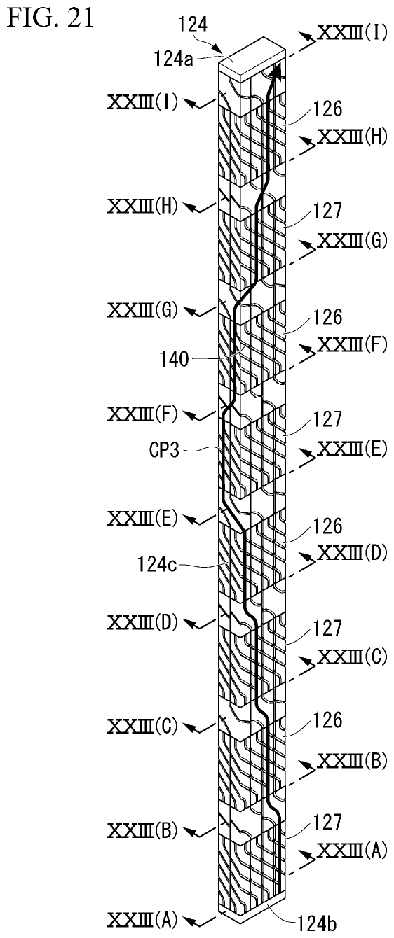

FIG. 21 is a perspective view showing the plate conductor disposed on the rotor side in the second embodiment. As shown in FIG. 21, the plate conductor 124 is formed by, for example, eight conductors from the side of one end 124a toward the other end 124b in the axial direction. Specifically, the eight conductors have four first conductors 126, and four second conductors 127.

In the plate conductor 124, the second conductor 127, the first conductor 126, the second conductor 127, the first conductor 126, the second conductor 127, the first conductor 126, the second conductor 127, and the first conductor 126 are sequentially continuously formed from the other end 31Ab toward the one end 31Aa in the axial direction. Further, the number of parts obtained by dividing the plate conductor 124 in the axial direction is not limited to eight but may be arbitrarily set.

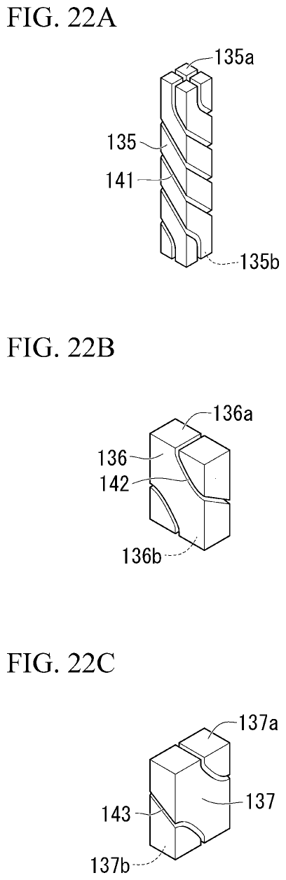

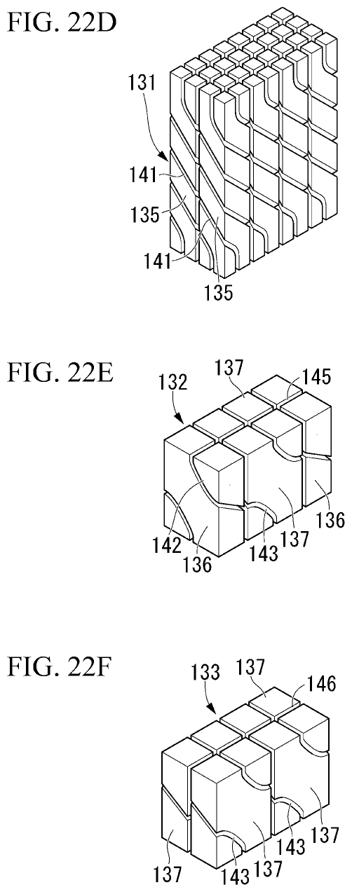

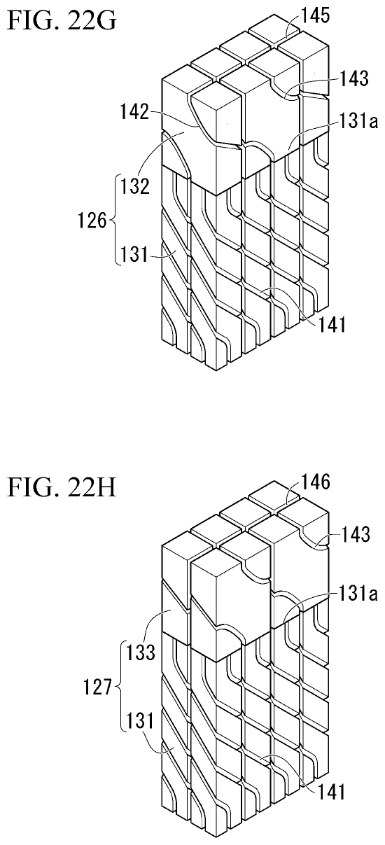

FIG. 22A is a perspective view of a first part in the plate conductor disposed on the rotor side of the second embodiment. FIG. 22B is a perspective view of a second part in the plate conductor disposed on the rotor side of the second embodiment. FIG. 22C is a perspective view of a third part in the plate conductor disposed on the rotor side of the second embodiment. FIG. 22D is a perspective view of a third conductor in the plate conductor disposed on the rotor side of the second embodiment. FIG. 22E is a perspective view of a fourth conductor in the plate conductor disposed on the rotor side of the second embodiment. FIG. 22F is a perspective view of a fifth conductor in the plate conductor disposed on the rotor side of the second embodiment. FIG. 22G is a perspective view of a first conductor in the plate conductor disposed on the rotor side of the second embodiment. FIG. 22H is a perspective view of a second conductor in the plate conductor disposed on the rotor side of the second embodiment.

As shown in FIG. 22A to FIG. 22H, a third conductor 131 has eight first parts 135. The first part 135 is formed with, for example, a rectangular cross-sectional outline, and extends in the axial direction. For example, a first slit 141 is formed in the first part 135 with one spiral rotation from one end 135a toward the other end 135b. In the third conductor 131, the four first parts 135 are disposed in the circumferential direction on an inner side in the radial direction. In addition, in the third conductor 131, the four first parts 135 are disposed in the circumferential direction on an outer side in the radial direction.

A fourth conductor 132 has two second parts 136, and two third parts 137. The second part 136 is formed in, for example, a rectangular shape, a cross-sectional outline of which is elongated in the radial direction, and extends in the axial direction. A second slit 142 is formed in the second part 136 in the twisted state from one end 136a toward the other end 136b. The third part 137 is formed in, for example, a rectangular shape, a cross-sectional outline of which is elongated in the circumferential direction, and extends in the axial direction. A third slit 143 is formed in the third part 137 in the twisted state from one end 137a toward the other end 137b.

In the fourth conductor 132, the two second parts 136 are disposed at an interval in the circumferential direction, and the two third parts 137 are disposed on an inner side in the radial direction and an outer side in the radial direction between the two second parts 136. The fourth conductor 132 is formed such that a dividing slit 145 dividing the fourth conductor 132 into a plurality of layers (in the second embodiment, two layers) in the radial direction extends in the circumferential direction. The fourth conductor 132 is not limited to two layers but may be divided into three or more layers.

A fifth conductor 133 has the four third parts 137. In the fifth conductor 133, the two third parts 137 are disposed on an inner side in the radial direction, and the two third parts 137 are disposed on an outer side in the radial direction. The fifth conductor 133 is formed such that a dividing slit 146 dividing the fifth conductor 133 into a plurality of layers (in the second embodiment, two layers) in the radial direction extends in the circumferential direction. The fifth conductor 133 is not limited to two layers but may be three or more layers.

In the first conductor 126, the fourth conductor 132 is connected to one end 131a of the third conductor 131. In the first conductor 126, slits such as the first slit 141, the second slit 142, the third slit 143, the dividing slit 145, and the like, are continuous. A larger number of slits are formed in the first conductor 126 compared to the first conductor 52 (see FIG. 12C) of the first embodiment. By combining the first conductor 126 with the third conductor 131 and the fourth conductor 132, the number of twists of the slit can be appropriately adjusted.

In the second conductor 127, the fifth conductor 133 is connected to the one end 131a of the third conductor 131. In the second conductor 127, slits such as the first slit 141, the third slit 143, the dividing slit 146, and the like, are continuous. A larger number of slits are formed in the second conductor 127 compared to the second conductor 53 (see FIG. 12D) of the first embodiment. By combining the second conductor 127 with the third conductor 131 and the fifth conductor 133, the number of twists of the slit can be appropriately adjusted.

As shown in FIG. 21, FIG. 22G and FIG. 22H, the plate conductor 124 is configured by alternately and continuously forming the second conductors 127 and the first conductors 126. In this state, the slits such as the first slit 141, the second slit 142, the third slit 143, the dividing slits 145 and 146, and the like, are continuous from the one end 124a to the other end 124b of the plate conductor 124. A slit 140 is formed by the slits such as the first slit 141, the second slit 142, the third slit 143, the dividing slits 145 and 146, and the like, which are continuous. The slit 140 is formed in the twisted state from the one end 124a toward the other end 124b of the plate conductor 124.

The number of twists of the slit 140 from the one end 124a to the other end 124b of the plate conductor 124 can be appropriately adjusted as the plate conductor 124 is configured by alternately and continuously combining the second conductors 127 and the first conductors 126.

Here, as the plate conductor 124 is divided into two layers by the dividing slits 145 and 146, the slit 140 independent from each layer can be formed in the twisted state. A larger number of slits of the slit 140 can be secured compared to the slit 56 (see FIG. 11) of the plate conductor 31A.

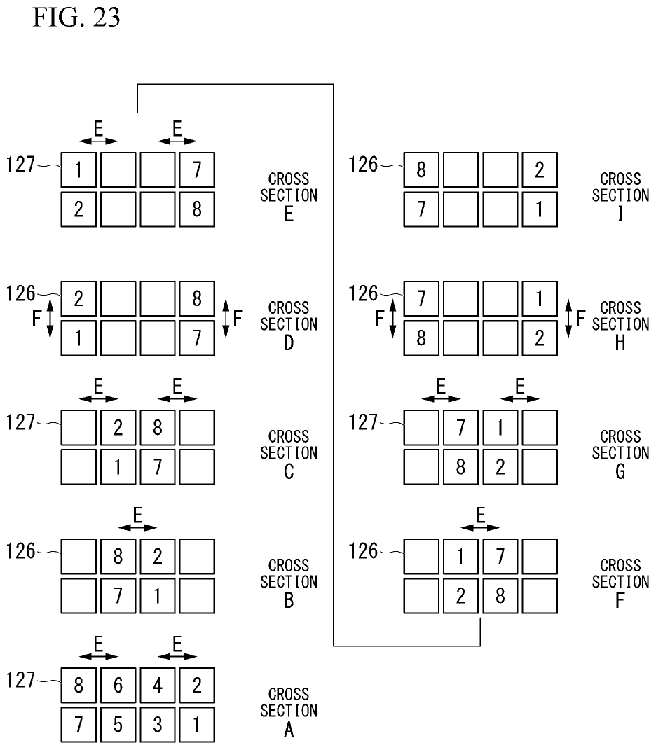

Next, an example in which the segment patterns of the plate conductor 124 periodically change positions from the other end 124b toward the one end 124a of the plate conductor 124 will be described with reference to FIG. 21 and FIG. 23.

FIG. 23 shows cross-sectional views taken along lines XXIII (A)-XXIII (A) to XXIII (I)-XXIII (I) in the plate conductor of FIG. 21. In FIG. 23, a first segment is expressed as “1,” a second segment is expressed as “2,” a third segment is expressed as “3,” and a fourth segment is expressed as “4.” In addition, a fifth segment is expressed as “5,” a sixth segment is expressed as “6,” a seventh segment is expressed as “7,” and an eighth segment is expressed as “8.”

As shown in FIG. 21 and FIG. 23, the segment patterns of the second conductor 127 and the first conductor 126 taken along lines XXIII (A)-XXIII (A) to XXIII (I)-XXIII (I) of the plate conductor 124 periodically change positions with each other. Specifically, in the segment patterns, the neighboring segments periodically change positions with each other like an arrow E in the circumferential direction, and the neighboring segments periodically change positions with each other like an arrow F in the radial direction.

Hereinafter, changing positions of the segment patterns taken along lines XXIII (A)-XXIII (A) to XXIII (I)-XXIII (I) of the plate conductor 124 will be described in detail using the first segment, the second segment, the seventh segment, and the eighth segment as representative examples.

In the segment pattern of the second conductor 127 taken along line XXIII (A)-XXIII (A) of the plate conductor 124, the first segment, the third segment, the fifth segment, and the seventh segment are disposed on an inner side in the radial direction in a row from the right side of the drawing toward the left side of the drawing. In addition, in the segment pattern of the second conductor 127, the second segment, the fourth segment, the sixth segment, and the eighth segment are disposed on an outer side in the radial direction in a row from the right side of the drawing toward the left side of the drawing.

In the first segment, the second segment, the seventh segment, and the eighth segment, the neighboring segments at a place taken along line XXIII (B)-XXIII (B) of the plate conductor 124 periodically change positions with each other like an arrow E in the circumferential direction.

In the segment pattern of the first conductor 126 taken along line XXIII (B)-XXIII (B) of the plate conductor 124, the first segment and the seventh segment are disposed next to each other, and the second segment and the eighth segment are disposed next to each other.

In the first segment, the second segment, the seventh segment, and the eighth segment, the neighboring segments at a place taken along line XXIII (C)-XXIII (C) of the plate conductor 124 periodically change positions with each other like an arrow E in the circumferential direction.

In the segment pattern of the second conductor 127 taken along line XXIII (C)-XXIII (C) of the plate conductor 124, the first segment and the seventh segment are disposed at positions that change positions with each other, and the second segment and the eighth segment are disposed at positions that change positions with each other.

In the first segment, the second segment, the seventh segment, and the eighth segment, the neighboring segments at a place taken along line XXIII (D)-XXIII (D) of the plate conductor 124 periodically change positions with each other like an arrow E in the circumferential direction.

In the segment pattern of the first conductor 126 taken along line XXIII (D)-XXIII (D) of the plate conductor 124, the first segment and the seventh segment are disposed at positions separated from each other, and the second segment and the eighth segment are disposed at positions separated from each other.

In the first segment, the second segment, the seventh segment, and the eighth segment, the neighboring segments at a place taken along line XXIII (E)-XXIII (E) of the plate conductor 124 periodically change positions with each other like an arrow F in the radial direction.

In the segment pattern of the second conductor 127 taken along line XXIII (E)-XXIII (E) of the plate conductor 124, the first segment and the second segment are disposed at positions that change positions with each other in the radial direction, and the seventh segment and the eighth segment are disposed at positions that change positions with each other in the radial direction.

In the first segment, the second segment, the seventh segment, and the eighth segment, the neighboring segments at a place taken along line XXIII (F)-XXIII (F) of the plate conductor 124 periodically change positions with each other like an arrow E in the circumferential direction.

In the segment pattern of the first conductor 126 taken along line XXIII (F)-XXIII (F) of the plate conductor 124, the first segment and the seventh segment are disposed next to each other, and the second segment and the eighth segment are disposed next to each other.

In the first segment, the second segment, the seventh segment, and the eighth segment, the neighboring segments at a place taken along line XXIII (G)-XXIII (G) of the plate conductor 124 periodically change positions with each other like an arrow E in the circumferential direction.

In the segment pattern of the second conductor 127 taken along line XXIII (G)-XXIII (G) of the plate conductor 124, the first segment and the seventh segment are disposed at positions that change positions with each other, and the second segment and the eighth segment are disposed at positions that change positions with each other.

In the first segment, the second segment, the seventh segment, and the eighth segment, the neighboring segments at a place taken along line XXIII (H)-XXIII (H) of the plate conductor 124 periodically change positions with each other like an arrow E in the circumferential direction.

In the segment pattern of the first conductor 126 taken along line XXIII (H)-XXIII (H) of the plate conductor 124, the first segment and the seventh segment are disposed at positions separated from each other, and the second segment and the eighth segment are disposed at positions separated from each other.

In the first segment, the second segment, the seventh segment, and the eighth segment, the neighboring segments at a place taken along line XXIII (I)-XXIII (I) of the plate conductor 124 periodically change positions with each other like an arrow F in the radial direction.

In the segment pattern of the first conductor 126 taken along line XXIII (I)-XXIII (I) of the plate conductor 124, the first segment and the second segment are disposed at positions that change positions with each other in the radial direction, and the seventh segment and the eighth segment are disposed at positions that change positions with each other in the radial direction.

In FIG. 21 and FIG. 23, among in a current path passing through the first segment, the second segment, the seventh segment, the eighth segment, and the like, which periodically change positions with each other, from the side of the rotor 12 (see FIG. 4), a current path CP3 passing through the first segment is shown by an arrow. The current path CP3 passing through the first segment first passes through the right side of the drawing at the other end 124b of the plate conductor 124. The current path CP3 passing through the other end 124b passes through the left side of the drawing at a center 124c of the plate conductor 124. The current path CP3 passing through the center 124c passes through the right side of the drawing at the one end 124a of the plate conductor 124. That is, the current path CP3 passes through the first segment with one cycle of twist from the other end 124b to the one end 124a of the plate conductor 124.

The current path passing through the second segment, the seventh segment, the eighth segment, and the like, also passes through each segments with one cycle of twist from the other end 124b to the one end 124a of the plate conductor 124 like the current path CP3 passing through the first segment.

In this way, by forming the slit 140 in the twisted state from the one end 124a to the other end 124b of the plate conductor 124, the periodic circular movement of the segment patterns allows the inter-linkage magnetic flux between the segments to be the same throughout the rod-shaped coil 120 (see FIG. 18). As a result, the induction voltage difference between the segments can be reduced, and the loss due to the circulating current caused by the induction voltage difference (i.e., circulation loss) can be minimized.

Further, as the plate conductor 124 is divided and subdivided by the slit 140 in the twisted state, the coil eddy current loss caused by occurrence of the eddy current can also be minimized.

Here, a larger coil eddy current loss occurs in the plate conductor 124 disposed on the side of the rotor 12 compared to the plate conductor 31A and the plate conductor 31B disposed on the side separated from the rotor 12. Here, the number of slits of the slit 140 provided in the plate conductor 124 is greater than the number of slits of the slit 56 (see FIG. 11) provided in the plate conductor 31A and the slit 42 (see FIG. 7) provided in the plate conductor 31B. Accordingly, the coil eddy current loss occurred in the plate conductor 124 can be appropriately minimized.

As described above, according to the plate conductor 124 of the second embodiment, the same effects as the plate conductors 31A of the first embodiment can be obtained.

Further, according to the rod-shaped coil 120 of the second embodiment, an application range of the rod-shaped coil 120 can be widened by continuously adding the second rod-shaped coil 122 to the rod-shaped coil 25 of the first embodiment.

Further, the technical range of the present invention is not limited to the embodiment, and various modifications may be made without departing from the scope of the present invention.

For example, in the embodiment, while the example in which the slits are formed in all the plate conductors including the rod-shaped coils 25, 120, or the like has been described, a slit may be formed at least a part of the plate conductor including the rod-shaped coils 25, 120, or the like. Since the slit is formed in a part of the plate conductor including the rod-shaped coils 25, 120, or the like, a shape of the rod-shaped coil can be simplified.

### [Variant]

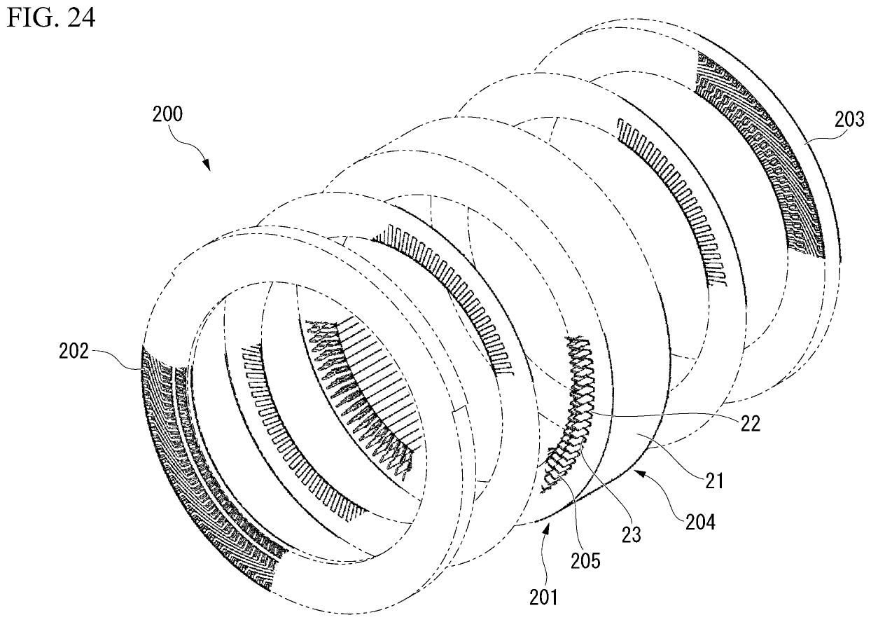

FIG. 24 is an exploded perspective view of a rotating electric machine of a variant according to the first embodiment.

In the variant of FIG. 24, the same or similar members as the rotating electric machine 10 of the first embodiment shown in FIG. 1 are designated by the same reference signs and detailed description thereof will be omitted.

A rotating electric machine 200 of the variant is distinguished from the rotating electric machine 10 of the first embodiment in that a stator 201 includes a pair of base plate assemblies 202 and 203. The base plate assembly 202 and the base plate assembly 203 are disposed on both sides of a stator core assembly 204, and a plurality of linear plate conductors 205 are sandwiched therebetween. In this case, the plate conductor 205 can also adopt a slit shape or a metal lamination molding method like the plate conductor 31 of the first embodiment.

In addition, the components in the embodiment can be appropriate4ly substituted with known components and the variants may be appropriately combined without departing from the scope of the present invention.

For example, while a stator of an inner rotor type rotating electric machine is used in the example, a stator of an outer rotor type rotating electric machine may be used. In addition, the twist of the current path from one end to the other end of the plate conductor is not limited to one cycle but may be two or more cycles. Further, while it has been described that all the rod-shaped coils including the plate conductors are manufactured by the metal lamination molding method using the metal 3D printer, the part manufactured by the metal lamination molding may be the plate conductor only, metal lamination molding can also be used as a rod-shaped coil aggregate for one rotating electric machine, which is made by arranging rod-shaped coils in an annular shape, and further, this may be molded integrally while including the base plate assembly.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A rotating electric machine comprising:
a stator having a rod-shaped coil which is disposed in a slot of a stator core, the rod-shaped coil including plate conductors in which slits are formed at least partially in a twisted state from one end toward other end in an axial direction; and
a rotor that is disposed adjacent to the stator and that rotates,
wherein the rod-shaped coil is continuously wound on the stator core, and
a number of slits of the plate conductor disposed on a side close to the rotor is greater than a number of slits of the plate conductor disposed on a side separated from the rotor.

2. The rotating electric machine according to claim 1, wherein, in the plate conductor disposed on the side close to the rotor,
a thickness of the stator core in a radial direction is greater than a thickness of the plate conductor disposed on the side separated from the rotor.

3. The rotating electric machine according to claim 2, wherein, in the plate conductor disposed on the side close to the rotor,
a dividing slit is formed such that the dividing slit extends in a circumferential direction of the stator core, the dividing slit being configured to divide the plate conductor disposed on the side close to the rotor into a plurality of layers in the radial direction, and
the slit is formed in a twisted state in each of the plurality of divided layers.

4. The rotating electric machine according to claim 2, wherein all of the plate conductors that are disposed between the side close to the rotor and the side separated from the rotor and that forms the rod-shaped coil are formed to have same cross-sectional areas with each other.

5. The rotating electric machine according to claim 4, wherein a segment pattern is provided in which one segment formed by the slit of the plate conductor periodically changes positions with another neighboring segment or another diagonally neighboring segment.

6. The rotating electric machine according to claim 5, wherein the plate conductor is formed such that changing positions of each segments starting from a starting point of the slit matches a segment pattern of the starting point at an ending point of the slit.

7. A method of manufacturing the rotating electric machine according to claim 1, comprising molding the plate conductor having the slit formed in the twisted state through metal lamination molding.

8. The method of manufacturing the rotating electric machine according to claim 7, wherein the rod-shaped coil including the plate conductor is spirally continuous, and the rod-shaped coil is molded integrally by metal lamination molding as a whole.
